SEQUENCE LISTING (25 sequences)

SEQ ID NO: 1 - DNA, 216 bp, Bacillus amyloliquefaciens
  source 1..216: mol_type = genomic DNA
  unsure 19: note = unidentified base
  unsure 36: note = unidentified base
  unsure 49: note = unidentified base
caagcgttgtccggaattnttgggcgtaaagggctncgcaggcggtttncttaagtctgatgtgaaagcccccggctcaaccggggagggtcatttggaaactggggaacttgagtgcagaagaggagagtggaattccacgtgtagcggtgaaatgcgtagagatgtggaggaacaccagtggcgaaggcgactctctggtctgtaactgacgct

SEQ ID NO: 2 - DNA, 205 bp, Gluconacetobacter liquefaciens
  source 1..205: mol_type = genomic DNA
cggaatgactgggcgtaaagggcgcgtaggcggtatggacagtcagatgtgaaattcctgggcttaacctgggggctgcatttgatacgtccaaaactagagtgtgagagagggttgtggaattcccagtgtagaggtgaaattcgtagatattgggaagaacaccggtggcgaaggcggcaacctggctcataactgacgctga

SEQ ID NO: 3 - DNA, 215 bp, unidentified
  source 1..215: mol_type = genomic DNA; note = Paraburkholderia sp. or Burkholderia sp.
cgttaatcggaattactgggcgtaaagcgtgcgcaggcggttcgctaagacagatgtgaaatccccgggcttaacctgggaactgcatttgtgactggcgggctagagtatggcagaggggggtagaattccacgtgtagcagtgaaatgcgtagagatgtggaggaataccgatggcgaaggcagccccctgggccaatactgacgctcatgca

SEQ ID NO: 4 - DNA, 237 bp, Gluconacetobacter liquefaciens
  source 1..237: mol_type = genomic DNA
aagggggctagcgttgctcggaatgactgggcgtaaagggcgcgtaggcggtatggacagtcagatgtgaaattcctgggcttaacctgggggctgcatttgatacgtccaaactagagtgtgagagagggttgtggaattcccagtgtagaggtgaaattcgtagatattgggaagaacaccggtggcgaaggcggcaacctggctcataactgacgctgaggcgcgaaagcgtgg

SEQ ID NO: 5 - DNA, 305 bp, Gluconacetobacter liquefaciens
  source 1..305: mol_type = genomic DNA
gaagggggctagcgttgctcggaatgactgggcgtaaagggcgcgtaggcggtatggacagtcagatgtgaaattcctgggcttaacctgggggctgcatttgatacgtccaaactagagtgtgagagagggttgtggaattcccagtgtagaggtgaaattcgtagatattgggaagaacaccggtggcgaaggcggcaacctggctcataactgacgctgaggcgcgaaagcgtggggagcaaacaggattagatacccccgtagtccctgtctcttatacacatctccgagcccacgagaca

SEQ ID NO: 6 - DNA, 260 bp, Pseudomonas fluorescens
  source 1..260: mol_type = genomic DNA
gcaagcgttaatcggaattactgggcgtaaagcgcgcgtaggtggttcgttaagttggatgtgaaatccccgggctcaacctgggaactgcattcaaaactgtcgagctagagtatggtagagggtggtggaatttcctgtgtagcggtgaaatgcgtagatataggaaggaacaccagtggcgaaggcgaccacctggactgatactgacactgaggtgcgaaagcgtggggagcaaacaggattagatacccccgtag

SEQ ID NO: 7 - DNA, 312 bp, unidentified
  source 1..312: mol_type = genomic DNA; note = Paraburkholderia sp. or Burkholderia sp.
gtaatacgtagggtgcaagcgttaatcggaattactgggcgtaaagcgtgcgcaggcggttcgctaagacagatgtgaaatccccgggcttaacctgggaactgcatttgtgactggcgggctagagtatggcagaggggggtagaattccacgtgtagcagtgaaatgcgtagagatgtggaggaataccgatggcgaaggcagccccctgggccaatactgacgctcatgcacgaaagcgtggggagcaaacaggattagatacccccgtagtccctgtctcttatacacatctccgagcccacgagaca

SEQ ID NO: 8 - DNA, 298 bp, unidentified
  source 1..298: mol_type = genomic DNA
gcaagcgttaatcggaattactgggcgtaaagcgcgcgtaggtggtttgttaagttggatgtgaaagccccgggctcaacctgggaactgcattcaaaactgacaagctagagtatggtagagggtggtggaatttcctgtgtagcggtgaaatgcgtagatataggaaggaacaccagtggcgaaggcgaccacctggactgatactgacactgaggtgcgaaagcgtggggagcaaacaggattagatacccccgtagtccctgtctcttatacacatctccgagcccacgagaca

SEQ ID NO: 9 - DNA, 364 bp, unidentified
  source 1..364: mol_type = genomic DNA; note = Paraburkholderia sp. or Burkholderia sp.
  unsure 109: note = unidentified base
  unsure 111: note = unidentified base
  unsure 112: note = unidentified base
tgttttgtcggcagcgtcagatgtgtataagagacaggtgtcagcagccgcggtaatacgtagggtgcaagcgttaatcggaattactgggcgtaaagcgtgcgcaggngnntcgctaagacagatgtgaaatccccgggcttaacctgggaactgcatttgtgactggcgggctagagtatggcagaggggggtagaattccacgtgtagcagtgaaatgcgtagagatgtggaggaataccgatggcgaaggcagccccctgggccaatactgacgctcatgcacgaaagcgtggggagcaaacaggattagataccccggtagtccctgtctcttatacacatctccgagcccacgagaca

SEQ ID NO: 10 - DNA, 228 bp, Pseudomonas lini
  source 1..228: mol_type = genomic DNA
caagcgttaatcggaattactgggcgtaaagcgcgcgtaggtggttcgttaagttggatgtgaaatccccgggctcaacctgggaactgcattcaaaactgtcgagctagagtatggtagagggtggtggaatttcctgtgtagcggtgaaatgcgtagatataggaaggaacaccagtggcgaaggcgaccacctggactgatactgacactgaggtgcgaaagcgt

SEQ ID NO: 11 - DNA, 302 bp, Gluconacetobacter liquefaciens
  source 1..302: mol_type = genomic DNA
  unsure 288: note = unidentified base
ttgtttcgtcggcagcgtcagatgtgtataagagacaggtgtcagccgccgcggtaatacgaagggggctagcgttgctcggaatgactgggcgtaaagggcgcgtaggcggtatggacagtcagatgtgaaattcctgggcttaacctgggggctgcatttgatacgtccaaactagagtgtgagagagggttgtggaattcccagtgtagaggtgaaattcgtagatattgggaagaacaccggtggcgaaggcggcaacctggctcataactgacgctgaggcgngaaagcgtggggag

SEQ ID NO: 12 - DNA, 227 bp, Gluconacetobacter liquefaciens
  source 1..227: mol_type = genomic DNA
aagggggctagcgttgctcggaatgactgggcgtaaagggcgcgtaggcggtatggacagtcagatgtgaaattcctgggcttaacctgggggctgcatttgatacgtccaaactagagtgtgagagagggttgtggaattcccagtgtagaggtgaaattcgtagatattgggaagaacaccggtggcgaaggcggcaacctggctcataactgacgctgaggcgc

SEQ ID NO: 13 - DNA, 226 bp, Gluconacetobacter liquefaciens
  source 1..226: mol_type = genomic DNA
aagggggctagcgttgctcggaatgactgggcgtaaagggcgcgtaggcggtatggacagtcagatgtgaaattcctgggcttaacctgggggctgcatttgatacgtccaaactagagtgtgagagagggttgtggaattcccagtgtagaggtgaaattcgtagatattgggaagaacaccggtggcgaaggcggcaacctggctcataactgacgctgaggcg

SEQ ID NO: 14 - DNA, 235 bp, Gluconacetobacter liquefaciens
  source 1..235: mol_type = genomic DNA
aagggggctagcgttgctcggaatgactgggcgtaaagggcgcgtaggcggtatggacagtcagatgtgaaattcctgggcttaacctgggggctgcatttgatacgtccaaactagagtgtgagagagggttgtggaattcccagtgtagaggtgaaattcgtagatattgggaagaacaccggtggcgaaggcggcaacctggctcataactgacgctgaggcgcgaaagcgt

SEQ ID NO: 15 - DNA, 237 bp, Pseudomonas sp.
  source 1..237: mol_type = genomic DNA
tgcaagcgttaatcggaattactgggcgtaaagcgcgcgtaggtggttcgttaagttggatgtgaaatccccgggctcaacctgggaactgcattcaaaactgtcgagctagagtatggtagagggtggtggaatttcctgtgtagcggtgaaatgcgtagatataggaaggaacaccagtggcgaaggcgaccacctggactgatactgacactgaggtgcgaaagcgtggggagc

SEQ ID NO: 16 - DNA, 228 bp, Gluconacetobacter liquefaciens
  source 1..228: mol_type = genomic DNA
  unsure 15: note = unidentified base
agggggctagcgttnctcggaatgactgggcgtaaagggcgcgtaggcggtatggacagtcagatgtgaaattcctgggcttaacctgggggctgcatttgatacgtccaaactagagtgtgagagagggttgtggaattcccagtgtagaggtgaaattcgtagatattgggaagaacaccggtggcgaaggcggcaacctggctcataactgacgctgaggcgcga

SEQ ID NO: 17 - DNA, 213 bp, Cyberlindnera sp.
  source 1..213: mol_type = genomic DNA; note = Cyberlindnera mrakii or Cyberlindnera saturnus
  unsure 183: note = unidentified base
  unsure 198: note = unidentified base
aggtgaacctgcggaaggatcattaaagtattcttcggtgcagccagcgcttccacagcgcggcagcccaaaccttacacactgtgattagttttttctactatttactttggctgcacgaagtggccaaaggttcttaaacacaaaagatttatatctttttttacaaaatttagtcaatgnagttttaatactatnatctttcaaaacttt

SEQ ID NO: 18 - DNA, 220 bp, Hanseniaspora uvarum
  source 1..220: mol_type = genomic DNA
  unsure 4: note = unidentified base
  unsure 9: note = unidentified base
  unsure 157: note = unidentified base
  unsure 160: note = unidentified base
  unsure 210: note = unidentified base
aatngcgcngcttctttagagtgtcgcagtaaaagtagtcttgcttgaatctcagtcaacgctacacacattcggagtttttttattttattttatttctttcgcttttgattcaaagggtccaggccaaaaaccaaccccaaccattttaatttantantatttttttaacctaacccaaatttcctaccgaaatttttaaattatttnaaacctttca

SEQ ID NO: 19 - DNA, 373 bp, Torulaspora delbrueckii
  source 1..373: mol_type = genomic DNA
  unsure 103: note = unidentified base
ccattaagaagaaattctatatgaatgaagttagaggacgtctaaagatactgtaagagaggatctggttcaagaccagcgcttaattgcgcggttgcggctnggttcgccttttgcggaacatgtcttttctcgttgttaactctacttcaacttctacaacactgtggagttttctacacaacttttcttctttgggaagatacgtcttgtgcgtgcttcccagaggtgacaaacacaaacaactttttattattataaaccagtcaaaaccaatttcgttatgaaattaaaaatatttaaaactttcaacaacggatctcttggttctcgcatcgatgaagaacgcagcctgtctcttatacacatctcc

SEQ ID NO: 20 - DNA, 123 bp, Cutaneotrichosporon moniliiforme
  source 1..123: mol_type = genomic DNA
gtgaattgctctctgagcgttaaactatatccatctacacctgtgaactgttgattgacttcggtcgaattacttttacaaacattgtgtaatgaacgtcatgttattataacaaaaaataac

SEQ ID NO: 21 - DNA, 177 bp, unidentified
  source 1..177: mol_type = genomic DNA; note = Cutaneotrichosporon sp. or Trichosporon sp.
tcgtaacaaggtttccgtaggtgaacctgcggaaggatcattagtgaattgctctctgagcgttaaactatatccatctacacctgtgaactgttgattgacttcggtcaattacttttacaaacattgtgtaatgaacgtcatgttattataacaaaaataactttcaacaacgga

SEQ ID NO: 22 - DNA, 228 bp, Pseudomonas sp.; identical to SEQ ID NO: 10
  source 1..228: mol_type = genomic DNA

SEQ ID NO: 23 - DNA, 251 bp, Bacillus amyloliquefaciens
  source 1..251: mol_type = genomic DNA
acgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacag

SEQ ID NO: 24 - DNA, 250 bp, Gluconobacter cerinus
  source 1..250: mol_type = genomic DNA
cgaagggggctagcgttgctcggaatgactgggcgtaaagggcgcgtaggcggtttatgcagtcagatgtgaaatccccgggcttaacctgggaactgcatttgagacgcatagactagaggtcgagagagggttgtggaattcccagtgtagaggtgaaattcgtagatattgggaagaacaccggtggcgaaggcggcaacctggctcgatactgacgctgaggcgcgaaagcgtggggagcaaacag

SEQ ID NO: 25 - DNA, 364 bp, Hanseniaspora uvarum
  source 1..364: mol_type = genomic DNA
agtcgtaacaaggtttccgtaggtgaacctgcggaaggatcattagattgaattatcattgttgctcgagttcttgtttagatcttttacaataatgtgtatctttattgaagatgtgcgcttaattgcgctgcttctttaaagtgtcgcagtgaaagtagtcttgcttgaatctcagtcaacgctacacacattggagtttttttactttaatttaattctttctgctttgaatcgaaaggttcaaggcaaaaaacaaacacaaacaattttattttattataattttttaaactaaaccaaaattcctaacggaaattttaaaataatttaaaactttcaacaacggatctcttggttctct

(19) United States
(12) Patent Application Publication
(10) Pub. No.: US 2026/0150847 A1
(43) Pub. Date: Jun. 4, 2026

(54) MICROBIAL COMPOSITIONS FOR USE WITH PLANTS FOR THE PREVENTION OR REDUCTION OF FUNGAL PATHOGENS

(71) Applicant: NIHON NOHYAKU CO., LTD., Tokyo (JP)

(72) Inventors: Veronica GARCIA, Brisbane, CA (US); Sofia ANDRIKOPOULOS, Brisbane, CA (US); Jesina FROLAND, Brisbane, CA (US); Kelly TRINIDAD, Brisbane, CA (US); Christy PIAMONTE, Brisbane, CA (US); James PEARCE, Brisbane, CA (US); Jamie BACHER, Brisbane, WA (US)

(73) Assignee: NIHON NOHYAKU CO., LTD., Tokyo (JP)

(21) Appl. No.: 18/389,620

(22) Filed: Dec. 19, 2023

Related U.S. Application Data
(63) Continuation of application No. 17/666,449, filed on Feb. 7, 2022, now abandoned.
Application No. 17/666,449 is a continuation of application No. PCT/US2020/045426, filed on Aug. 7, 2020.
(60) Provisional application No. 62/885,114, filed on Aug. 9, 2019.

(51) Int. Cl. A01N 63/22; A01N 63/20; A01N 63/50; A01P 3/00

(52) U.S. Cl. CPC A01N 63/22; A01N 63/20; A01N 63/50; A01P 3/00

(57) ABSTRACT

Disclosed herein are biocontrol compositions against plant fungal pathogens and methods of use thereof for the prevention or reduction of crop loss or food spoilage. The biocontrol composition may comprise at least one microbe, or a secondary metabolite of the at least one microbe, with anti-fungal or anti-pathogenic activity. The methods and compositions disclosed herein may prevent or inhibit the growth of a variety of different pathogens, including pathogens of the genus Penicillium. The biocontrol compositions may be applied to a plant, a seed, or a produce thereof or to a packaging material used to transport or store the produce.

### CROSS-REFERENCE

This application is a continuation application of U.S. patent application Ser. No. 17/666,449, filed Feb. 7, 2022, which is a continuation application of International Patent Application No. PCT/US2020/045426, filed Aug. 7, 2020, which claims priority to U.S. Provisional Application No. 62/885,114, filed Aug. 9, 2019, each of which is incorporated by reference herein in its entirety.

### SEQUENCE LISTING

Incorporated by reference in its entirety herein is a computer-readable nucleotide/amino acid sequence listing submitted concurrently herewith and identified as follows: One 36,049 Byte xml (Extensible Markup Language) file named “768898_ReplacmentSeqeueneListing-2nd.xml,” created on Aug. 22, 2024.

### BACKGROUND

Fungal pathogens cause significant agricultural loss, leading to loss of crops, food waste and economic loss. Microbes having anti-fungal properties have been developed as biological control agents to reduce both crop loss and food spoilage by these fungal pathogens. Commercially available products may not show the desired plant or fungal specificity or effectiveness. Furthermore, there are limited options for post-harvest protection of produce, particularly organic produce. Biocontrol compositions to prevent fungal growth can provide alternatives to currently available products.

### SUMMARY

In an aspect, the present disclosure provides a biocontrol composition, comprising: (i) at least one microbe, or a metabolite produced by the at least one microbe, and (ii) a carrier, wherein the at least one microbe comprises a 16S rRNA sequence that is greater than 99% identical to a 16S rRNA sequence of SEQ ID NO: 1, SEQ ID NO: 22, or SEQ ID NO: 23, and wherein the biocontrol composition is capable of inhibiting growth of a Penicillium species relative to a control that is not exposed to the biocontrol composition. In some embodiments, the at least one microbe comprises the 16S rRNA sequence is greater than 99% identical to a 16S rRNA sequence of SEQ ID NO: 1. In some embodiments, the 16S rRNA sequence is greater than 99% identical to a 16S rRNA sequence of SEQ ID NO: 22. In some embodiments, the 16S rRNA sequence is greater than 99% identical to a 16S rRNA sequence of SEQ ID NO: 23.

In an aspect, the present disclosure provides a biocontrol composition, comprising: (i) at least one microbe, or a metabolite produced by the at least one microbe, and (ii) a carrier, wherein the at least one microbe comprises a 16S rRNA sequence that is greater than 90% identical to a 16S rRNA sequence of SEQ ID NO: 24, or wherein the at least one microbe comprises an internal transcribed spacer (ITS) sequence that is greater than 90% identical to an ITS sequence of SEQ ID NO: 25, wherein the biocontrol composition is capable of inhibiting growth of a Penicillium species relative to a control that is not exposed to the biocontrol composition. In some embodiments, the at least one microbe comprises the 16S rRNA sequence that is greater than 90% identical to a 16S rRNA sequence of SEQ ID NO: 24. In some embodiments, the at least one microbe comprises the 16S rRNA sequence that is greater than 99% identical to a 16S rRNA sequence of SEQ ID NO: 24. In some embodiments, the at least one microbe comprises an internal transcribed spacer (ITS) sequence that is greater than 90% identical to an ITS sequence of SEQ ID NO: 25. In some embodiments, the at least one microbe comprises an internal transcribed spacer (ITS) sequence that is greater than 99% identical to an ITS sequence of SEQ ID NO: 25. In some embodiments, the at least one microbe is at least two microbes comprising a first microbe comprising the 16S rRNA sequence that is greater than 90% identical to the 16S rRNA sequence of SEQ ID NO: 24 and a second microbe comprising the ITS sequence that is greater than 90% identical to the ITS sequence of SEQ ID NO: 25. In some embodiments, the growth inhibition of the Penicillium species is shown by a reduction in lesion size or tissue necrosis in produce to which the biocontrol composition as compared to the control that is not exposed to the biocontrol composition. In some embodiments, the biocontrol composition is capable of inhibiting growth of the Penicillium species 5% or more relative to a control not exposed to the biocontrol composition. In some embodiments, the biocontrol composition is capable of inhibiting growth of the Penicillium species 25% or more relative to a control not exposed to the biocontrol composition. In some embodiments, the Penicillium is a Penicillium expansum. In some embodiments, the Penicillium is a Penicillium digitatum. In some embodiments, the biocontrol composition comprises a vegetative cell. In some embodiments, the biocontrol composition comprises a spore. In some embodiments, the carrier is selected from the group consisting of: oil, water, wax, resin, kaolinite clay, diatomaceous earth, or grain flour. In some embodiments, the carrier is water. In some embodiments, the biocontrol composition is formulated in a liquid form. In some embodiments, the biocontrol composition is formulated in a liquid form. In some embodiments, the biocontrol composition is formulated in a powder form.

In another aspect, the present disclosure provides a method of reducing or preventing the growth of a pathogen on a plant, a seed, a flower, or a produce thereof comprising: applying the biocontrol composition to the plant, seed flower or produce thereof.

In another aspects, the present disclosure provides a method of reducing or preventing the growth of a pathogen on a plant, a seed, a flower, or a produce thereof comprising: applying the biocontrol composition to an object or area adjacent to the plant, seed flower or produce thereof. In some embodiments, the applying is performed prior to harvesting the plant, seed, flower, or produce. In some embodiments, the applying is performed after harvesting the plant, seed, flower, or produce. In some embodiments, the area adjacent to the plant comprises soil used to grow the plant, seed, flower, or produce thereof. In some embodiments, the object adjacent to the plant comprises packaging used to store or transport the plant, seed, flower, or produce. In some embodiments, the applying is performed by spraying the biocontrol composition. In some embodiments, the applying is performed by dipping a plant, a seed, a flower, or a produce in the biocontrol composition. In some embodiments, the plant is selected from the group consisting of almond, apricot, apple, artichoke, banana, barley, beet, blackberry, blueberry, broccoli, Brussels sprout, cabbage, cannabis, canola, capsicum, carrot, celery, chard, cherry, citrus, corn, cucurbit, date, fig, flax, garlic, grape, herb, spice, kale, lettuce, mint, oil palm, olive, onion, pea, pear, peach, peanut, papaya, parsnip, pecan, persimmon, plum, pomegranate, potato, quince, radish, raspberry, rose, rice, sloe, sorghum, soybean, spinach, strawberry, sweet potato, tobacco, tomato, turnip greens, walnut, and wheat. In some embodiments, the plant is an apple. In some embodiments, the plant is a member of the genus Malus. In some embodiments, the plant is a member of the genus Citrus. In some embodiments, the citrus comprises a mandarin, lemon, lime, navel orange, pomelo, or a hybrid thereof.

In another aspect, the present disclosure provides a method of inhibiting growth of a pathogen, comprising: applying a biocontrol composition to an apple, wherein the biocontrol composition comprises: (i) at least one microbe, or a metabolite produced by the at least one microbe, and (ii) a carrier, wherein the at least one microbe comprises a 16S rRNA sequence that is greater than 99% identical to a 16S rRNA sequence of SEQ ID NO: 1, SEQ ID NO: 22, or SEQ ID NO: 23, and wherein the biocontrol composition is capable of inhibiting growth of a Penicillium expansum species relative to a control that is not exposed to the biocontrol composition.

In another aspect, the present disclosure provides a method of inhibiting growth of a pathogen, comprising: applying a biocontrol composition to an apple, wherein the biocontrol composition comprises: (i) a first microbe and a second microbe, or a metabolite produced by the first microbe or the second microbe, and (ii) a carrier, wherein the first microbe comprising the 16S rRNA sequence that is greater than 90% identical to the 16S rRNA sequence of SEQ ID NO: 24 and the second microbe comprising the ITS sequence that is greater than 90% identical to the ITS sequence of SEQ ID NO: 25, and wherein the biocontrol composition is capable of inhibiting growth of a Penicillium expansum species relative to a control that is not exposed to the biocontrol composition. In another aspect, the present disclosure provides a method of inhibiting growth of a pathogen, comprising: applying a biocontrol composition to a citrus plant, wherein the biocontrol composition comprises: (i) at least one microbe, or a metabolite produced by the at least one microbe, and (ii) a carrier, wherein the at least one microbe comprises a 16S rRNA sequence that is greater than 99% identical to a 16S rRNA sequence of SEQ ID NO: 1, SEQ ID NO: 22, or SEQ ID NO: 23, and wherein the biocontrol composition is capable of inhibiting growth of a Penicillium expansum species relative to a control that is not exposed to the biocontrol composition.

In another aspect, the present disclosure provides a method of inhibiting growth of a pathogen, comprising: applying a biocontrol composition to an citrus plant, wherein the biocontrol composition comprises: (i) a first microbe and a second microbe, or a metabolite produced by the first microbe or the second microbe, and (ii) a carrier, wherein the first microbe comprising the 16S rRNA sequence that is greater than 90% identical to the 16S rRNA sequence of SEQ ID NO: 24 and the second microbe comprising the ITS sequence that is greater than 90% identical to the ITS sequence of SEQ ID NO: 25, and wherein the biocontrol composition is capable of inhibiting growth of a Penicillium expansum species relative to a control that is not exposed to the biocontrol composition.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows a schematic for the methods of using and generating biocontrol compositions.

FIG. 2 illustrates mean lesion size of treated and untreated Fuji and Gala apples.

FIG. 3 illustrates apple decay of treated and untreated Fuji and Gala apples.

FIG. 4A-4B illustrate mean lesion size and mean weight of necrosis in treated and untreated Fuji apples.

FIG. 5 illustrates Fuji apples 6 days after infection.

FIG. 6A-6B illustrate mean lesion size and mean weight of necrosis in treated and untreated Gala apples.

FIG. 7 illustrates Gala apples 6-7 days after infection.

FIG. 8A shows a schematic for plating location of the biocontrol compositions. FIG. 8B shows photographs of the growth of the biocontrol compositions on citrus media plates.

FIG. 9 shows photographs of the inhibition of P. digitatum on citrus media plates.

FIG. 10 shows photographs of the inhibition of P. digitatum on citrus media plates.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Provided herein are compositions, formulations, and methods of use thereof, of microbes, microbial consortia, or collections of microbes for use on plants for the prevention or reduction of pathogens. Compositions, formulations, and methods described herein also relate to a supernatant or culture composition generated from or comprising microbes, microbial consortia, or collections of microbes for use on plants for the prevention or reduction or pathogens. These compositions may be referred to as biocontrol compositions. In particular, the compositions and formulations, and methods of use thereof may be effective on fungal pathogens. The fungal pathogen may be a member of the Penicillium genus. For example, the fungal pathogen may be Penicillium expansum, otherwise known as Blue Mold. In another example, the fungal pathogen may be Penicillium digitatum. The fungal pathogen may be Botrytis cinerea.

The plant may be a flower, seed or produce. The plant, flower, seed, or produce thereof can be of an almond, apricot, apple, artichoke, banana, barley, beet, blackberry, blueberry, broccoli, Brussels sprout, cabbage, cannabis, canola, capsicum, carrot, celery, chard, cherry, citrus, corn, cucurbit, date, fig, flax, garlic, grape, herb, spice, kale, lettuce, mint, oil palm, olive, onion, pea, pear, peach, peanut, papaya, parsnip, pecan, persimmon, plum, pomegranate, potato, quince, radish, raspberry, rose, rice, sloe, sorghum, soybean, spinach, strawberry, sweet potato, tobacco, tomato, turnip greens, walnut, or wheat. The plant may be a member of the Citrus or Malus genus. For example, the plant may be mandarin, lemon, or navel orange. The plant may be an apple. The plant may be a particular cultivar. For example, the apple may be a Fuji apple.

### Selection of Microbial Consortia

Methods for identifying or selecting biocontrol compositions comprising microbial consortia can be used. For example, methods as disclosed in U.S. Patent Publication No. U.S. 20180127796 can be used for identifying or selecting for microbial consortia. In some cases, a plurality of microbes can be grown together. In some cases, the method can comprise diluting a sample to form plurality of dilution, wherein a dilution in the plurality of dilutions comprises a subset of the plurality of microbes. The dilutions may allow for the generation of a plurality of subsets in which different microbes of the plurality of microbes are allowed to interact. The subset of the plurality of microbes can be subjected to culturing such that the microbes may proliferate. The subsets can be subjected to sequencing reactions such that sequences of the microbes can be obtained. From the sequencing reaction, the species, strain, or other taxonomic information can be obtained. Sequences to identify a particular microbe are discussed elsewhere herein. The subsets can be subjected to varying culturing times such can be subjected to sequencing reactions at various times to monitor the presences and/or relative abundance of a particular species, strain or other taxonomic category. By observing the changes in the presence and/or relative abundance of a particular species, strain or other taxonomic category, the interaction between multiple microbes can be determined. For example, a first microbe may have a higher relative abundance when cultured with a second microbe when compared to a relative abundance when not cultured with the second microbe. In this example, the first microbe may interact with the second microbe such that the first microbe's overall viability is increased. The plurality of dilutions can each be subjected to sequencing reactions such that the microbes of each dilution can be identified, and can allow for a multiplexed, high throughput approach.

The plurality of microbes can be diluted such that a subset of the plurality of microbes are grown together. In some cases, diluting the plurality of microbes serially to form a plurality of serial dilutions of the sample can be performed. Microbes in the plurality of serial dilutions of the sample can be due to dispersal or chance. The plurality of serial dilutions can be different in different implementations. In some embodiments, the plurality of serial dilutions of the sample can comprise, or about, 1:10, 1:100, 1:1000, 1:10000, 1:100000, 1:1000000, 1:10000000, 1:100000000, 1:1000000000, or a number or a range between any two of these values, dilutions of the sample. In some embodiments, the plurality of serial dilutions of the sample can comprise at least, or at most, 1:10, 1:100, 1:1000, 1:10000, 1:100000, 1:1000000, 1:10000000, 1:100000000, or 1:1000000000 dilutions of the sample. For example, a sample can be diluted 10 times into a 1:10 dilution of the sample using, for example, a buffer. The 1:10 dilution of the sample can be diluted 10 times into a 1:100 dilution of the sample. The plurality of serial dilutions can comprise the 1:10 dilution of the sample, 1:100 dilution of the sample, and other dilutions of the sample similarly prepared. As another example, a sample can be diluted 10 times into a 1:10 dilution of the sample using, for example, a buffer. The sample can be diluted 100 times into a 1:100 dilution of the sample. The plurality of serial dilutions can comprise the 1:10 dilution of the sample, 1:100 dilution of the sample, and other dilutions of the sample similarly prepared.

In some embodiments, cultivating the plurality of dilutions of the sample in the first cultivation condition comprises cultivating the plurality of dilutions of the sample in the first cultivation condition for a plurality of time durations, which can vary by as little as one minute, up to one year.

The plurality of microbes can be subjected to a sequencing reaction and specific microbes can be identified. Upon culturing the subsets for durations of time, the overall percentage representation of each microbe in the subset may change from the percentage at the start of culturing. For example, microbes which remain viable among other microbes after different periods of culturing may indicate a symbiotic relationship or interaction between the microbes of the culture and these microbes may form a microbial consortium. The microbial consortia can be tested for efficacy of inhibiting the growth of a fungal pathogen in a manner similar to methods used for identifying the efficacy of the at least one microbe as described elsewhere herein.

Isolation of particular microbes may also be performed for use in methods or compositions described elsewhere herein. For example, the plurality of microbes can be subjected to serial dilutions such that a colony of a particular microbe can be isolated. The serial dilutions can each be cultured in liquid, semi-solid, or solid media. On a semi-solid or solid media such as an agar plate, the plurality of microbes can form colonies. The colonies can be well dispersed so that a colony can contain a single strain or species of microbe. Isolation of a particular microbe can also be performed using physical separation methods such a centrifugation. For example, a plurality of microbes may be cultured in liquid media and centrifuged in order to isolate the microbes from the culture. A particular microbe may also be isolated using a particular growth condition. For example, a particular microbe may have higher viability when compared to another microbe when cultured in anaerobic conditions. A particular microbe may have a high viability compared to another microbe when cultured in a media rich in a particular nutrient.

### Compositions for the Prevention or Reduction of Crop Loss and Food Spoilage

Disclosed herein are biocontrol compositions which can prevent or reduce the growth of a fungal pathogen on a plant, a seed, or a produce thereof. The term “produce” can be used herein to refer to the edible portion of a plant, such as for example, the leaves, the stem, the seeds, the root, the flowers or the fruit. The term “plant” can be used herein to refer to any portion of the plant, such as for example the leaves, the stem, the seeds, the root, or the fruit. Preventing or reducing the growth of fungal pathogens on the plant, the seed, or the produce thereof can reduce the amount of crop loss and food spoilage prior to, during, or after harvesting the produce from the plant.

The at least one microbe can be a bacterium or a yeast. The at least one microbe can comprise a microbe from a genus selected from the group consisting of: Bacillus, Burkholderia, Cutaneotrichosporon, Cyberlindnera, Gluconacetobacter, Gluconobacter, Hanseniaspora, Paraburkholderia, Pseudomonas, Torulaspora, and any combination thereof.

The at least one microbe can comprise a microbe selected from the group consisting of: Bacillus amyloliquefaciens, Bacillus subtilis, Bacillus velezensis, Cutaneotrichosporon jirovecii, Cutaneotrichosporon moniliiforme, Cutaneotrichosporon mucoides, Cyberlindnera mrakii, Cyberlindnera saturnus, Gluconacetobacter liquefaciens, Gluconobacter cerinus, Hanseniaspora uvarum, Paraburkholderia phytofirmans, Pseudomonas fluorescens, Pseudomonas frederiksbergensis, Pseudomonas lini, Pseudomonas migulae, Torulaspora delbrueckii and any combination thereof.

The at least one microbe can be a microbe from the genus Bacillus. The at least one microbe can be a microbe from the genus Burkholderia. The at least one microbe can be a microbe from the genus Cutaneotrichosporon. The at least one microbe can be a microbe from the genus Cyberlindnera. The at least one microbe can be a microbe from the genus Gluconacetobacter. The at least one microbe can be a microbe from the genus Gluconobacter. The at least one microbe can be a microbe from the genus Hanseniaspora. The at least one microbe can be a microbe from the genus Paraburkholderia. The at least one microbe can be a microbe from the genus Pseudomonas. The at least one microbe can be a microbe from the genus Torulaspora.

The at least one microbe can be Bacillus amyloliquefaciens. The at least one microbe can be Bacillus subtilis. The at least one microbe can be Bacillus velezensis. The at least one microbe can be Cutaneotrichosporon jivrovecii. The at least one microbe can be Cutaneotrichosporon moniliiforme. The at least one microbe can be Cutaneotrichosporon mucoides. The at least one microbe can be Cyberlindnera mrakii. The at least one microbe can be Cyberlindnera saturnus. The at least one microbe can be Gluconacetobacter liquefaciens. The at least one microbe can be Gluconobacter cerinus. The at least one microbe can be Hanseniaspora uvarum. The at least one microbe can be Paraburkholderia phytofirmans. The at least one microbe can be Paraburkholderia fluroescens. The at least one microbe can be Paraburkholderia frederiksbergensis. The at least one microbe can be Pseudomonas lini. The at least one microbe can be Pseudomonas migulae. The at least one microbe can be Torulaspora delbrueckii.

The at least one microbe can comprise at least one microbe with at least about: 70%, 75%, 80%, 85%, 87%, 90%, 91%, 92%, 93%, 94%, 95%, 96%, 97%, 98%, 99%, 99.5%, or 100% sequence identity to the rRNA of a microorganism selected from the group consisting of: Bacillus amyloliquefaciens, Bacillus subtilis, Bacillus velezensis, Cutaneotrichosporon jirovecii, Cutaneotrichosporon moniliiforme, Cutaneotrichosporon mucoides, Cyberlindnera mrakii, Cyberlindnera saturnus, Gluconacetobacter liquefaciens, Gluconobacter cerinus, Hanseniaspora uvarum, Paraburkholderia phytofirmans, Pseudomonas fluorescens, Pseudomonas frederiksbergensis, Pseudomonas lini, Pseudomonas migulae, Torulaspora delbrueckii, and any combination thereof. The rRNA can be a 16S rRNA, a 23S rRNA, an internal transcribed spacer (ITS), or a combination thereof. The at least one microbe can be a combination of microbe strains from one or more microbe species.

The biocontrol composition can comprise: (i) at least one microbe or a secondary metabolite of the at least one microbe, and (ii) a carrier, and wherein the at least one microbe has a 16S rRNA sequence greater than 98% identical to a 16S rRNA sequence selected from the group of SEQ ID NO: 1 and SEQ ID NO: 9 or wherein the at least one microbe has an ITS sequence greater than 98% identical to an ITS sequence selected from the group of SEQ ID NO: 17 and SEQ ID NO: 20 or wherein the at least one microbe has an ITS sequence greater than 90% identical to an ITS sequence of SEQ ID NO: 18.

The microbe can comprise an RNA sequence with at least about: 85%, 87%, 90%, 92%, 95%, 96%, 97%, 98%, 99%, 99.5%, or 100% sequence identity to a sequence selected from the group consisting of: SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 14, SEQ ID NO: 15, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID 23, SEQ ID 24, and SEQ ID 25.

The biocontrol composition can further comprise a second microbe, wherein the second microbe is not identical to the at least one microbe. The second microbe can comprise an RNA sequence with at least about: 85%, 87%, 90%, 92%, 95%, 96%, 97%, 98%, 99%, 99.5%, or 100% sequence identity to a sequence selected from the group consisting of: SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 14, SEQ ID NO: 15, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO 23, SEQ ID NO: 24, and SEQ ID NO 25. In some cases, the first microbe and the second microbe are the same species. For example, the first microbe and the second microbe may both be Bacillus amyloliquefaciens. In a further non-limiting example, a first microbe and a second microbe, and optionally more than two microbes, each different strains of the same species, may be included in a biocontrol composition as disclosed herein. In some cases, the first microbe and second microbe are not the same species. For example, the first microbe may be Gluconobacter cerinus and the second microbe may be Hanseniaspora uvarum. In some cases, the first microbe and second microbe are not the same genus. In some cases, the first microbe and second microbe are not in the same family. In some cases, the first microbe and second microbe are not in the same order. In some cases, the first microbe and second microbe are not in the same class. In some cases, the first microbe and second microbe are not in the same phylum. In some cases, the first microbe and second microbe are not in the same kingdom.

In one embodiment, the at least one microbe comprises at least one microbe with at least about: 85%, 87%, 90%, 92%, 95%, 96%, 97%, 98%, 99%, 99.5%, or 100% sequence identity to a rRNA sequence from a Bacillus species. The Bacillus species can be Bacillus amyloliquefaciens, Bacillus subtilis, or Bacillus velezensis. The rRNA sequence can be a 16S sequence. In one embodiment, the at least one microbe comprises at least one microbe with at least about: 85%, 87%, 90%, 92%, 95%, 96%, 97%, 98%, 99%, 99.5%, or 100% sequence identity to SEQ ID NO: 1 or SEQ ID NO: 23.

In one embodiment, the at least one microbe comprises at least one microbe with at least about: 85%, 87%, 90%, 92%, 95%, 96%, 97%, 98%, 99%, 99.5%, or 100% sequence identity to a rRNA sequence from a Gluconacetobacter species. The Gluconacetobacter species can be Gluconacetobacter liquefaciens. The rRNA sequence can be a 16S sequence. In one embodiment, the at least one microbe comprises at least one microbe with at least about: 85%, 87%, 90%, 92%, 95%, 96%, 97%, 98%, 99%, 99.5%, or 100% sequence identity to SEQ ID NO: 2, SEQ ID NO: 4, SEQ ID NO: 5, SEQ IS NO: 11, SEQ ID NO: 12, SEQ ID NO: 13, SEQ ID NO: 14, or SEQ ID NO: 16.

In one embodiment, the at least one microbe comprises at least one microbe with at least about: 85%, 87%, 90%, 92%, 95%, 96%, 97%, 98%, 99%, 99.5%, or 100% sequence identity to a rRNA sequence from a Gluconobacter species. The Gluconobacter species can be Gluconobacter cerinus. The rRNA sequence can be a 16S sequence. In one embodiment, the at least one microbe comprises at least one microbe with at least about: 85%, 87%, 90%, 92%, 95%, 96%, 97%, 98%, 99%, 99.5%, or 100% sequence identity to SEQ ID NO: 24.

In one embodiment, the at least one microbe comprises at least one microbe with at least about: 85%, 87%, 90%, 92%, 95%, 96%, 97%, 98%, 99%, 99.5%, or 100% sequence identity to a rRNA sequence from a Burkholderia species or a Paraburkholderia species. The Paraburkholderia species can be Paraburkholderia phytofirmans. The rRNA sequence can be a 16S sequence. In one embodiment, the at least one microbe comprises at least one microbe with at least about: 85%, 87%, 90%, 92%, 95%, 96%, 97%, 98%, 99%, 99.5%, or 100% sequence identity to SEQ ID NO: 3, SEQ ID NO: 7, or SEQ ID NO: 9.

In one embodiment, the at least one microbe comprises at least one microbe with at least about: 85%, 87%, 90%, 92%, 95%, 96%, 97%, 98%, 99%, 99.5%, or 100% sequence identity to a rRNA sequence from a Pseudomonas species. The Pseudomonas species can be Pseudomonas fluorescens, Pseudomonas lini, Pseudomonas migulae, or Pseudomonas frederiksbergensis. The rRNA sequence can be a 16S sequence. In one embodiment, the at least one microbe comprises at least one microbe with at least about: 85%, 87%, 90%, 92%, 95%, 96%, 97%, 98%, 99%, 99.5%, or 100% sequence identity to SEQ ID NO: 6, SEQ ID NO: 10, SEQ ID NO: 15, or SEQ ID NO: 22.

In one embodiment, the at least one microbe comprises at least one microbe with at least about: 85%, 87%, 90%, 92%, 95%, 96%, 97%, 98%, 99%, 99.5%, or 100% sequence identity to SEQ ID NO: 8.

In one embodiment, the at least one microbe comprises at least one microbe with at least about: 85%, 87%, 90%, 92%, 95%, 96%, 97%, 98%, 99%, 99.5%, or 100% sequence identity to an rRNA sequence from a Cyberlindnera species. The Cyberlindnera species can be Cyberlindnera saturnus or Cyberlindnera mrakkii. The rRNA sequence can be an ITS sequence. In one embodiment, the at least one microbe comprises at least one microbe with at least about: 85%, 87%, 90%, 92%, 95%, 96%, 97%, 98%, 99%, 99.5%, or 100% sequence identity to SEQ ID NO: 17.

In one embodiment, the at least one microbe comprises at least one microbe with at least about: 85%, 87%, 90%, 92%, 95%, 96%, 97%, 98%, 99%, 99.5%, or 100% sequence identity to an rRNA sequence from a Hanseniaspora species. The Hanseniaspora species can be Hanseniaspora uvarum. The rRNA sequence can be an ITS sequence. In one embodiment, the at least one microbe comprises at least one microbe with at least about: 85%, 87%, 90%, 92%, 95%, 96%, 97%, 98%, 99%, 99.5%, or 100% sequence identity to SEQ ID NO: 18 or SEQ ID: 25. In one embodiment, the at least one microbe comprises at least one microbe with at least 90% sequence identity to SEQ ID NO: 18 or SEQ ID: 25. In one embodiment, the at least one microbe comprises at least one microbe with at least 95% sequence identity to SEQ ID NO: 18 or SEQ ID: 25. In one embodiment, the at least one microbe comprises at least one microbe with at least 99% sequence identity to SEQ ID NO: 18 or SEQ ID: 25.

In one embodiment, the at least one microbe comprises at least one microbe with at least about: 85%, 87%, 90%, 92%, 95%, 96%, 97%, 98%, 99%, 99.5%, or 100% sequence identity to an rRNA sequence from a Torulaspora species. The Torulaspora species can be Torulaspora delbrueckii. The rRNA sequence can be an ITS sequence. In one embodiment, the at least one microbe comprises at least one microbe with at least about: 85%, 87%, 90%, 92%, 95%, 96%, 97%, 98%, 99%, 99.5%, or 100% sequence identity to SEQ ID NO: 19.

In one embodiment, the at least one microbe comprises at least one microbe with at least about: 85%, 87%, 90%, 92%, 95%, 96%, 97%, 98%, 99%, 99.5%, or 100% sequence identity to an rRNA sequence from a Cutaneotrichosporon species. The Cutaneotrichosporon species can be Cutaneotrichosporon moniliiforme, Cutaneotrichosporon jirovecii, or Cutaneotrichosporon mucoides. The rRNA sequence can be an ITS sequence. In one embodiment, the at least one microbe comprises at least one microbe with at least about: 85%, 87%, 90%, 92%, 95%, 96%, 97%, 98%, 99%, 99.5%, or 100% sequence identity to SEQ ID NO: 20 or SEQ ID NO: 21.

The biocontrol composition can comprise a consortium of microbes comprising a plurality of microbes. The plurality of microbes can be at least two microbes, at least three microbes, at least four microbes, at least five microbes, at least six microbes, at least seven microbes, at least eight microbes, at least nine microbes, or at least ten microbes. Each microbe of the plurality of microbes can be a different microbe. The biocontrol composition can comprise secondary metabolites from a consortium of microbes comprising a plurality of microbes, wherein the plurality of microbes is at least two microbes, at least three microbes, at least four microbes, at least five microbes, at least six microbes, at least seven microbes, at least eight microbes, at least nine microbes, or at least ten microbes.

The at least two microbes can comprise at least two microbes selected from the group consisting of: microbes with a 16S rRNA sequence selected from the group consisting of SEQ ID SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 14, SEQ ID NO: 15, SEQ ID NO: 16, SEQ ID NO: 22, SEQ ID NO: 23, SEQ ID NO: 24 and microbes with an ITS sequence selected from the group consisting of SEQ ID NO: 17, SEQ ID NO: 18, SEQ ID NO: 19, SEQ ID NO: 20, SEQ ID NO: 21, and SEQ ID NO 25. The at least two microbes can comprise a first microbe with a 16S rRNA sequence selected from SEQ ID NO: 1 or SEQ ID NO: 9 or wherein the first microbe has an ITS sequence greater than 98% identical to an ITS sequence selected from the group of SEQ ID NO: 17 and SEQ ID NO: 20 or wherein the first microbe has an ITS sequence greater than 90% identical to an ITS sequence of SEQ ID NO: 18. The at least two microbes can comprise a first microbe having an ITS sequence greater than 90% identical to SEQ ID NO: 18 and a second microbe can be a Gluconacetobacter species. The Gluconacetobacter species can be Gluconacetobacter liquefaciens. The Gluconacetobacter species can be a Gluconacetobacter species having a 16S rRNA sequence selected from the group consisting of: SEQ ID NO: 2, SEQ ID NO: 4, SEQ ID NO: 5, SEQ ID NO: 11, SEQ ID NO: 12, SEQ ID NO: 13, SEQ ID NO: 14, and SEQ ID NO: 16. The at least two microbes can comprise a first microbe being a Gluconobacter species and a second microbe being a Hanseniaspora species. The at least two microbes can comprise a first microbe being a Gluconobacter cerinus and a second microbe being a Hanseniaspora uvarum.

The at least two microbes can comprise a first microbe with a 16S sequence greater than 90% identical to SEQ ID NO: 24 and a second microbe with a ITS sequence greater than 90% identical to SEQ ID NO: 25. The at least two microbes can comprise a first microbe with a 16S sequence greater than 95% identical to SEQ ID NO: 24 and a second microbe with a ITS sequence greater than 95% identical to SEQ ID NO: 25. The at least two microbes can comprise a first microbe with a 16S sequence greater than 98% identical to SEQ ID NO: 24 and a second microbe with a ITS sequence greater than 98% identical to SEQ ID NO: 25.

The at least three microbes can comprise a first microbe with a with a 16S rRNA sequence greater than 99% identical to SEQ ID: 23, a second microbe with a 16S rRNA sequence greater than 99% identical to SEQ ID: 23, a third microbe with 16S rRNA sequence greater than 99% identical to SEQ ID: 23, wherein the first microbe, second microbe, and third microbe comprise genomes that are not identical. In some cases, the genomes may differ by a single nucleotide polymorphism (SNP). In some cases, the genomes may differ by more than one SNPs. In some cases, the genomes may differ by the number of the genes in each genome. In some cases, the genomes may differ by rearrangements, such as insertions, deletions, reordering, refactoring or lysogenic or inactive phage, insertion sequences, repetitive genomic sequence or other differing contents of genomic regions or genes. In some cases, the cellular DNA content may differ by the inclusion of one or more plasmids, which may differ from strain to strain. In some case, the genomes may code for different isoforms of the genes. For example, an expressed protein from the gene may contain a point mutation, a deletion, an insertion, which may affect the function of the protein. For example, an expressed protein from the gene may contain a point mutation, a deletion, an insertion, which may not affect the function of the protein, or which may not substantially affect the function of the protein.

The at least three microbes can comprise at least three microbes selected from the group consisting of microbes with a 16S rRNA sequence selected from the group consisting of microbes with a 16S rRNA sequence selected from the group consisting of SEQ ID SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 14, SEQ ID NO: 15, SEQ ID NO: 16, SEQ ID NO: 22, SEQ ID NO: 23, and SEQ ID NO:24 and microbes with an ITS sequence selected from the group consisting of SEQ ID NO: 17, SEQ ID NO: 18, SEQ ID NO: 19, SEQ ID NO: 20, SEQ ID NO: 21, and SEQ ID NO: 25. The at least three microbes can comprise at least one microbe with a 16S rRNA sequence selected from SEQ ID NO: 1, SEQ ID NO: 9, or SEQ ID 23 or an ITS sequence selected from SEQ ID NO: 17, SEQ ID NO: 18, or SEQ ID NO:20.

The at least four microbes can comprise at least four microbes selected from the group consisting of microbes with a 16S rRNA sequence selected from the group consisting of microbes with a 16S rRNA sequence selected from the group consisting of SEQ ID SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 14, SEQ ID NO: 15, SEQ ID NO: 16, SEQ ID NO: 22, SEQ ID NO: 23, and SEQ ID NO:24 and microbes with an ITS sequence selected from the group consisting of SEQ ID NO: 17, SEQ ID NO: 18, SEQ ID NO: 19, SEQ ID NO: 20, SEQ ID NO: 21, and SEQ ID NO: 25. The at least four microbes can comprise at least one microbe with a 16S rRNA sequence selected from SEQ ID NO: 1 SEQ ID NO: 9 or SEQ ID NO:23 or an ITS sequence selected from SEQ ID NO: 17, SEQ ID NO: 18, or SEQ ID NO:20.

The at least five microbes can comprise at least five microbes selected from the group consisting of microbes with a 16S rRNA sequence selected from the group consisting of microbes with a 16S rRNA sequence selected from the group consisting of SEQ ID SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 14, SEQ ID NO: 15, SEQ ID NO: 16, SEQ ID NO: 22, SEQ ID NO: 23, and SEQ ID NO:24 and microbes with an ITS sequence selected from the group consisting of SEQ ID NO: 17, SEQ ID NO: 18, SEQ ID NO: 19, SEQ ID NO: 20, SEQ ID NO: 21, and SEQ ID NO: 25. The at least five microbes can comprise at least one microbe with a 16S rRNA sequence selected from SEQ ID NO: 1 SEQ ID NO: 9 or SEQ ID 23 or an ITS sequence selected from SEQ ID NO: 17, SEQ ID NO: 18, or SEQ ID NO: 20.

Table 1 illustrates the microbial strain identifiers, putative microbial genus or species, and corresponding SEQ ID NOs described herein. The at least one microbe can be a microbe in Table 1. Table 2 illustrates the sequences corresponding to these SEQ ID NOs.

TABLE 1
Microbial strains with anti-fungal activity

| Microbial | Putative microbial | | 16S |
|---|---|---|---|
| strain | | | or |
| identifier(s) | genus or species | SEQ ID NO. | ITS |
| 28B; BC8 | Bacillus amyloliquefaciens | SEQ ID NO: 1 | 16S |
| 74A.1; BC12 | Gluconacetobacter liquefaciens | SEQ ID NO: 2 | 16S |
| 41A2 | Paraburkholderia or | SEQ ID NO: 3 | 16S |
| | Burkholderia | | |
| 253A; B253 | Gluconacetobacter liquefaciens | SEQ ID NO: 4 | 16S |
| 254A; B254; | Gluconacetobacter liquefaciens | SEQ ID NO: 5 | 16S |
| BC13 | | | |
| B125.D, 125B | Pseudomonas fluorescens | SEQ ID NO: 6 | 16S |
| 41A; F41A | Paraburkholderia or | SEQ ID NO: 7 | 16S |
| | Burkholderia | | |
| 41A.l; F41A.l | Unknown | SEQ ID NO: 8 | 16S |
| 41A.2; | Paraburkholderia or | SEQ ID NO: 9 | 16S |
| F41A.2; | Burkholderia | | |
| BC10 | | | |
| B31 | Pseudomonas lini | SEQ ID NO: 10 | 16S |
| 233B; BC11 | Gluconacetobacter liquefaciens | SEQ ID NO: 11 | 16S |
| 234B; B234 | Gluconacetobacter liquefaciens | SEQ ID NO: 12 | 16S |
| 239B; B239 | Gluconacetobacter liquefaciens | SEQ ID NO: 13 | 16S |
| B240; BC15 | Gluconacetobacter liquefaciens | SEQ ID NO: 14 | 16S |
| B125B2; | Pseudomonas sp. | SEQ ID NO: 15 | 16S |
| B125.B2 | | | |
| 258B; BC14 | Gluconacetobacter liquefaciens | SEQ ID NO: 16 | 16S |
| 1C; BC1 | Cyberlindnera mrakii or | SEQ ID NO: 17 | ITS |
| | Cyberlindnera saturnus | | |
| 74.2; BC2 | Hanseniaspora uvarum | SEQ ID NO: 18 | ITS |
| 74.3; BC9 | Torulaspora delbrueckii | SEQ ID NO: 19 | ITS |
| 125B; | Cutaneotrichosporon | SEQ ID NO: 20 | ITS |
| B125B1A | moniliiforme | | |
| 125B.1; | Cutaneotrichosporon or | SEQ ID NO: 21 | ITS |
| B125B1 | Trichosporon | | |
| BC16 | Pseudomonas sp. | SEQ ID NO: 22 | 16S |
| BC17 | Bacillus amyloliquefaciens | SEQ ID NO: 23 | 16S |
| BC18 | Gluconobacter cerinus | SEQ ID NO: 24 | 16S |
| BC18 | Hanseniaspora uvarum | SEQ ID NO: 25 | ITS |

TABLE 2
Sequences

| SEQ ID NO | Sequence |
|---|---|
| SEQ ID NO: 1 | CAAGCGTTGTCCGGAATTNTTGGGCGTAAAGGGCTNC |
| | GCAGGCGGTTTNCTTAAGTCTGATGTGAAAGCCCCCG |
| | GCTCAACCGGGGAGGGTCATTTGGAAACTGGGGAACT |
| | TGAGTGCAGAAGAGGAGAGTGGAATTCCACGTGTAG |
| | CGGTGAAATGCGTAGAGATGTGGAGGAACACCAGTG |
| | GCGAAGGCGACTCTCTGGTCTGTAACTGACGCT |
| SEQ ID NO: 2 | CGGAATGACTGGGCGTAAAGGGCGCGTAGGCGGTAT |
| | GGACAGTCAGATGTGAAATTCCTGGGCTTAACCTGGG |
| | GGCTGCATTTGATACGTCCAAAACTAGAGTGTGAGAG |
| | AGGGTTGTGGAATTCCCAGTGTAGAGGTGAAATTCGT |
| | AGATATTGGGAAGAACACCGGTGGCGAAGGCGGCAA |
| | CCTGGCTCATAACTGACGCTGA |
| SEQ ID NO: 3 | CGTTAATCGGAATTACTGGGCGTAAAGCGTGCGCAGG |
| | CGGTTCGCTAAGACAGATGTGAAATCCCCGGGCTTAA |
| | CCTGGGAACTGCATTTGTGACTGGCGGGCTAGAGTAT |
| | GGCAGAGGGGGGTAGAATTCCACGTGTAGCAGTGAA |
| | ATGCGTAGAGATGTGGAGGAATACCGATGGCGAAGG |
| | CAGCCCCCTGGGCCAATACTGACGCTCATGCA |
| SEQ ID NO: 4 | AAGGGGGCTAGCGTTGCTCGGAATGACTGGGCGTAAA |
| | GGGCGCGTAGGCGGTATGGACAGTCAGATGTGAAATT |
| | CCTGGGCTTAACCTGGGGGCTGCATTTGATACGTCCA |
| | AACTAGAGTGTGAGAGAGGGTTGTGGAATTCCCAGTG |
| | TAGAGGTGAAATTCGTAGATATTGGGAAGAACACCGG |
| | TGGCGAAGGCGGCAACCTGGCTCATAACTGACGCTGA |
| | GGCGCGAAAGCGTGG |
| SEQ ID NO: 5 | GAAGGGGGCTAGCGTTGCTCGGAATGACTGGGCGTAA |
| | AGGGCGCGTAGGCGGTATGGACAGTCAGATGTGAAA |
| | TTCCTGGGCTTAACCTGGGGGCTGCATTTGATACGTCC |
| | AAACTAGAGTGTGAGAGAGGGTTGTGGAATTCCCAGT |
| | GTAGAGGTGAAATTCGTAGATATTGGGAAGAACACCG |
| | GTGGCGAAGGCGGCAACCTGGCTCATAACTGACGCTG |
| | AGGCGCGAAAGCGTGGGGAGCAAACAGGATTAGATA |
| | CCCCCGTAGTCCCTGTCTCTTATACACATCTCCGAGCC |
| | CACGAGACA |
| SEQ ID NO: 6 | GCAAGCGTTAATCGGAATTACTGGGCGTAAAGCGCGC |
| | GTAGGTGGTTCGTTAAGTTGGATGTGAAATCCCCGGG |
| | CTCAACCTGGGAACTGCATTCAAAACTGTCGAGCTAG |
| | AGTATGGTAGAGGGTGGTGGAATTTCCTGTGTAGCGG |
| | TGAAATGCGTAGATATAGGAAGGAACACCAGTGGCG |
| | AAGGCGACCACCTGGACTGATACTGACACTGAGGTGC |
| | GAAAGCGTGGGGAGCAAACAGGATTAGATACCCCCG |
| | TAG |
| SEQ ID NO: 7 | GTAATACGTAGGGTGCAAGCGTTAATCGGAATTACTG |
| | GGCGTAAAGCGTGCGCAGGCGGTTCGCTAAGACAGAT |
| | GTGAAATCCCCGGGCTTAACCTGGGAACTGCATTTGT |
| | GACTGGCGGGCTAGAGTATGGCAGAGGGGGGTAGAA |
| | TTCCACGTGTAGCAGTGAAATGCGTAGAGATGTGGAG |
| | GAATACCGATGGCGAAGGCAGCCCCCTGGGCCAATAC |
| | TGACGCTCATGCACGAAAGCGTGGGGAGCAAACAGG |
| | ATTAGATACCCCCGTAGTCCCTGTCTCTTATACACATC |
| | TCCGAGCCCACGAGACA |
| SEQ ID NO: 8 | GCAAGCGTTAATCGGAATTACTGGGCGTAAAGCGCGC |
| | GTAGGTGGTTTGTTAAGTTGGATGTGAAAGCCCCGGG |
| | CTCAACCTGGGAACTGCATTCAAAACTGACAAGCTAG |
| | AGTATGGTAGAGGGTGGTGGAATTTCCTGTGTAGCGG |
| | TGAAATGCGTAGATATAGGAAGGAACACCAGTGGCG |
| | AAGGCGACCACCTGGACTGATACTGACACTGAGGTGC |
| | GAAAGCGTGGGGAGCAAACAGGATTAGATACCCCCG |
| | TAGTCCCTGTCTCTTATACACATCTCCGAGCCCACGAG |
| | ACA |
| SEQ ID NO: 9 | TGTTTTGTCGGCAGCGTCAGATGTGTATAAGAGACAG |
| | GTGTCAGCAGCCGCGGTAATACGTAGGGTGCAAGCGT |
| | TAATCGGAATTACTGGGCGTAAAGCGTGCGCAGGNGN |
| | NTCGCTAAGACAGATGTGAAATCCCCGGGCTTAACCT |
| | GGGAACTGCATTTGTGACTGGCGGGCTAGAGTATGGC |
| | AGAGGGGGGTAGAATTCCACGTGTAGCAGTGAAATG |
| | CGTAGAGATGTGGAGGAATACCGATGGCGAAGGCAG |
| | CCCCCTGGGCCAATACTGACGCTCATGCACGAAAGCG |
| | TGGGGAGCAAACAGGATTAGATACCCCGGTAGTCCCT |
| | GTCTCTTATACACATCTCCGAGCCCACGAGACA |
| SEQ ID NO: 10 | CAAGCGTTAATCGGAATTACTGGGCGTAAAGCGCGCG |
| | TAGGTGGTTCGTTAAGTTGGATGTGAAATCCCCGGGC |
| | TCAACCTGGGAACTGCATTCAAAACTGTCGAGCTAGA |
| | GTATGGTAGAGGGTGGTGGAATTTCCTGTGTAGCGGT |
| | GAAATGCGTAGATATAGGAAGGAACACCAGTGGCGA |
| | AGGCGACCACCTGGACTGATACTGACACTGAGGTGCG |
| | AAAGCGT |
| SEQ ID NO: 11 | TTGTTTCGTCGGCAGCGTCAGATGTGTATAAGAGACA |
| | GGTGTCAGCCGCCGCGGTAATACGAAGGGGGCTAGC |
| | GTTGCTCGGAATGACTGGGCGTAAAGGGCGCGTAGGC |
| | GGTATGGACAGTCAGATGTGAAATTCCTGGGCTTAAC |
| | CTGGGGGCTGCATTTGATACGTCCAAACTAGAGTGTG |
| | AGAGAGGGTTGTGGAATTCCCAGTGTAGAGGTGAAAT |
| | TCGTAGATATTGGGAAGAACACCGGTGGCGAAGGCG |
| | GCAACCTGGCTCATAACTGACGCTGAGGCGNGAAAGC |
| | GTGGGGAG |
| SEQ ID NO: 12 | AAGGGGGCTAGCGTTGCTCGGAATGACTGGGCGTAAA |
| | GGGCGCGTAGGCGGTATGGACAGTCAGATGTGAAATT |
| | CCTGGGCTTAACCTGGGGGCTGCATTTGATACGTCCA |
| | AACTAGAGTGTGAGAGAGGGTTGTGGAATTCCCAGTG |
| | TAGAGGTGAAATTCGTAGATATTGGGAAGAACACCGG |
| | TGGCGAAGGCGGCAACCTGGCTCATAACTGACGCTGA |
| | GGCGC |
| SEQ ID NO: 13 | AAGGGGGCTAGCGTTGCTCGGAATGACTGGGCGTAAA |
| | GGGCGCGTAGGCGGTATGGACAGTCAGATGTGAAATT |
| | CCTGGGCTTAACCTGGGGGCTGCATTTGATACGTCCA |
| | AACTAGAGTGTGAGAGAGGGTTGTGGAATTCCCAGTG |
| | TAGAGGTGAAATTCGTAGATATTGGGAAGAACACCGG |
| | TGGCGAAGGCGGCAACCTGGCTCATAACTGACGCTGA |
| | GGCG |
| SEQ ID NO: 14 | AAGGGGGCTAGCGTTGCTCGGAATGACTGGGCGTAAA |
| | GGGCGCGTAGGCGGTATGGACAGTCAGATGTGAAATT |
| | CCTGGGCTTAACCTGGGGGCTGCATTTGATACGTCCA |
| | AACTAGAGTGTGAGAGAGGGTTGTGGAATTCCCAGTG |
| | TAGAGGTGAAATTCGTAGATATTGGGAAGAACACCGG |
| | TGGCGAAGGCGGCAACCTGGCTCATAACTGACGCTGA |
| | GGCGCGAAAGCGT |
| SEQ ID NO: 15 | TGCAAGCGTTAATCGGAATTACTGGGCGTAAAGCGCG |
| | CGTAGGTGGTTCGTTAAGTTGGATGTGAAATCCCCGG |
| | GCTCAACCTGGGAACTGCATTCAAAACTGTCGAGCTA |
| | GAGTATGGTAGAGGGTGGTGGAATTTCCTGTGTAGCG |
| | GTGAAATGCGTAGATATAGGAAGGAACACCAGTGGC |
| | GAAGGCGACCACCTGGACTGATACTGACACTGAGGTG |
| | CGAAAGCGTGGGGAGC |
| SEQ ID NO: 16 | AGGGGGCTAGCGTTNCTCGGAATGACTGGGCGTAAAG |
| | GGCGCGTAGGCGGTATGGACAGTCAGATGTGAAATTC |
| | CTGGGCTTAACCTGGGGGCTGCATTTGATACGTCCAA |
| | ACTAGAGTGTGAGAGAGGGTTGTGGAATTCCCAGTGT |
| | AGAGGTGAAATTCGTAGATATTGGGAAGAACACCGGT |
| | GGCGAAGGCGGCAACCTGGCTCATAACTGACGCTGAG |
| | GCGCGA |
| SEQ ID NO: 17 | AGGTGAACCTGCGGAAGGATCATTAAAGTATTCTTCG |
| | GTGCAGCCAGCGCTTCCACAGCGCGGCAGCCCAAACC |
| | TTACACACTGTGATTAGTTTTTTCTACTATTTACTTTGG |
| | CTGCACGAAGTGGCCAAAGGTTCTTAAACACAAAAGA |
| | TTTATATCTTTTTTTACAAAATTTAGTCAATGNAGTTT |
| | TAATACTATNATCTTTCAAAACTTT |
| SEQ ID NO: 18 | AATNGCGCNGCTTCTTTAGAGTGTCGCAGTAAAAGTA |
| | GTCTTGCTTGAATCTCAGTCAACGCTACACACATTCGG |
| | AGTTTTTTTATTTTATTTTATTTCTTTCGCTTTTGATTC |
| | AAAGGGTCCAGGCCAAAAACCAACCCCAACCATTTTA |
| | ATTTANTANTATTTTTTTAACCTAACCCAAATTTCCTA |
| | CCGAAATTTTTAAATTATTTNAAACCTTTCA |
| SEQ ID NO: 19 | CCATTAAGAAGAAATTCTATATGAATGAAGTTAGAGG |
| | ACGTCTAAAGATACTGTAAGAGAGGATCTGGTTCAAG |
| | ACCAGCGCTTAATTGCGCGGTTGCGGCTNGGTTCGCC |
| | TTTTGCGGAACATGTCTTTTCTCGTTGTTAACTCTACTT |
| | CAACTTCTACAACACTGTGGAGTTTTCTACACAACTTT |
| | TCTTCTTTGGGAAGATACGTCTTGTGCGTGCTTCCCAG |
| | AGGTGACAAACACAAACAACTTTTTATTATTATAAAC |
| | CAGTCAAAACCAATTTCGTTATGAAATTAAAAATATT |
| | TAAAACTTTCAACAACGGATCTCTTGGTTCTCGCATCG |
| | ATGAAGAACGCAGCCTGTCTCTTATACACATCTCC |
| SEQ ID NO: 20 | GTGAATTGCTCTCTGAGCGTTAAACTATATCCATCTAC |
| | ACCTGTGAACTGTTGATTGACTTCGGTCGAATTACTTT |
| | TACAAACATTGTGTAATGAACGTCATGTTATTATAAC |
| | AAAAAATAAC |
| SEQ ID NO: 21 | TCGTAACAAGGTTTCCGTAGGTGAACCTGCGGAAGGA |
| | TCATTAGTGAATTGCTCTCTGAGCGTTAAACTATATCC |
| | ATCTACACCTGTGAACTGTTGATTGACTTCGGTCAATT |
| | ACTTTTACAAACATTGTGTAATGAACGTCATGTTATTA |
| | TAACAAAAATAACTTTCAACAACGGA |
| SEQ ID NO: 22 | CAAGCGTTAATCGGAATTACTGGGCGTAAAGCGCGCG |
| | TAGGTGGTTCGTTAAGTTGGATGTGAAATCCCCGGGC |
| | TCAACCTGGGAACTGCATTCAAAACTGTCGAGCTAGA |
| | GTATGGTAGAGGGTGGTGGAATTTCCTGTGTAGCGGT |
| | GAAATGCGTAGATATAGGAAGGAACACCAGTGGCGA |
| | AGGCGACCACCTGGACTGATACTGACACTGAGGTGCG |
| | AAAGCGT |
| SEQ ID NO: 23 | ACGTAGGTGGCAAGCGTTGTCCGGAATTATTGGGCGT |
| | AAAGGGCTCGCAGGCGGTTTCTTAAGTCTGATGTGAA |
| | AGCCCCCGGCTCAACCGGGGAGGGTCATTGGAAACTG |
| | GGGAACTTGAGTGCAGAAGAGGAGAGTGGAATTCCA |
| | CGTGTAGCGGTGAAATGCGTAGAGATGTGGAGGAAC |
| | ACCAGTGGCGAAGGCGACTCTCTGGTCTGTAACTGAC |
| | GCTGAGGAGCGAAAGCGTGGGGAGCGAACAG |
| SEQ ID NO: 24 | CGAAGGGGGCTAGCGTTGCTCGGAATGACTGGGCGTA |
| | AAGGGCGCGTAGGCGGTTTATGCAGTCAGATGTGAAA |
| | TCCCCGGGCTTAACCTGGGAACTGCATTTGAGACGCA |
| | TAGACTAGAGGTCGAGAGAGGGTTGTGGAATTCCCAG |
| | TGTAGAGGTGAAATTCGTAGATATTGGGAAGAACACC |
| | GGTGGCGAAGGCGGCAACCTGGCTCGATACTGACGCT |
| | GAGGCGCGAAAGCGTGGGGAGCAAACAG |
| SEQ ID NO: 25 | AGTCGTAACAAGGTTTCCGTAGGTGAACCTGCGGAAG |
| | GATCATTAGATTGAATTATCATTGTTGCTCGAGTTCTT |
| | GTTTAGATCTTTTACAATAATGTGTATCTTTATTGAAG |
| | ATGTGCGCTTAATTGCGCTGCTTCTTTAAAGTGTCGCA |
| | GTGAAAGTAGTCTTGCTTGAATCTCAGTCAACGCTAC |
| | ACACATTGGAGTTTTTTTACTTTAATTTAATTCTTTCTG |
| | CTTTGAATCGAAAGGTTCAAGGCAAAAAACAAACAC |
| | AAACAATTTTATTTTATTATAATTTTTTAAACTAAACC |
| | AAAATTCCTAACGGAAATTTTAAAATAATTTAAAACT |
| | TTCAACAACGGATCTCTTGGTTCTCT |

The at least one microbe can be grown in a culture. The at least one microbe can be isolated and purified from the culture. The at least one microbe purified from the culture can comprise a vegetative cell or spore of the at least one microbe. The culture can be a solid or semi-solid medium. The culture can be a liquid medium. The culture can be a bioreactor. Any suitable bioreactor can be used. Examples of bioreactors include, but are not limited to a flask, continuously stirred tank bioreactor (CSTR), a bubbleless bioreactor, an airlift reactor, and a membrane bioreactor. In some instances, a supernatant of the culture comprises a secondary metabolite of the least one microbe. The secondary metabolite of the at least one microbe can be isolated and purified from the supernatant. In some cases, the supernatant can be applied as the biocontrol composition as described elsewhere herein.

The at least one microbe may be affected by other microbes. The microbes can behave synergistically when cultured together such that the anti-fungal properties are improved when cultured together compared to when cultured separately. For example, the at least one microbe may have increased viability when cultured with another microbe. The at least one microbe may have increased proliferation when cultured with another microbe. The at least one microbe may use chemicals or metabolites produced by another microbe. The at least one microbe may interact directly with another microbe. For example, the at least one microbe and another microbe may form biofilms or a multicellular structure. The at least one microbe may produce and/or secrete an increased amount of the secondary metabolite when cultured with another microbe. For example, the at least one microbe may produce an intermediate metabolite, which in turn is processed by another microbe resulting in the secondary metabolite. Methods disclosed elsewhere herein can be used to identify microbes which may benefit from culturing with another microbe, as well as identify biocontrol compositions comprising a first microbe and a second microbe wherein the second microbe is not identical to the first microbe.

The biocontrol composition can comprise one or more secondary metabolites of the at least one microbe. The one or more secondary metabolites can have antifungal properties of its own. The one or more secondary metabolites may with other microbes in a biocontrol composition have antifungal properties. The one or more secondary metabolites can be isolated from a supernatant of the culture of the at least one microbe. The one or more secondary metabolites can comprise a lipopeptide, a dipeptide, an aminopolyol, a protein, a siderophore, a phenazine compound, a polyketide, or a combination thereof.

The lipopeptide can be a linear lipopeptide or a cyclic lipopeptide (CLP). Examples of lipopeptides include, but are not limited to a surfactin, a fengycin, an iturin, a massetolide, an amphisin, an arthrofactin, a tolassin, a syringopeptide, a syringomycin, a putisolvin, a bacillomycin, a bacillopeptin, a bacitracin, a polymyxin, a daptomycin, a mycosubtilin, a kurstakin, a tensin, a plipastatin, a viscosin, and an echinocandin. The echinocandin can be echinocandin B (ECB). In some instances, the secondary metabolite is a surfactin, a fengycin, an iturin, or a combination thereof.

The dipeptide can be bacilysin or chlorotetain. The polyketide can be defficidin, macrolactin, bacillaene, butyrolactol A, soraphen A, hippolachnin A, or forazoline A. The secondary metabolite can be an aminopolyol. The aminopolyol can be zwittermicin A. The secondary metabolite can be a protein. The protein can be a bacisubin, subtilin, or a fungicin.

The siderophore can be a pyoverdine, thioquinolobactin, or a pyochelin. The phenazine compound can be a phenzine-1-carboxylic acid, a 1-hydroxyphenazine, or a phenazine-1-carboxaminde. The secondary metabolite can be a chitinase, a cellulase, an amylase, or a glucanase. The secondary metabolite can be a volatile antifungal compound.

The biocontrol composition can be formulated as a liquid formulation or a dry formulation. The liquid formulation can be a flowable or aqueous suspension. The liquid formulation can comprise the at least one microbe or a secondary metabolite thereof suspended in water, oil, or a combination thereof (an emulsion). A dry formulation can be a wettable powder, a dry flake, a dust, or a granule. A wettable powder can be applied to the plant, the seed, the flower, or the produce thereof as a suspension. A dust can be applied to the plant, the seed, or the produce thereof dry, such as to seeds or foliage. A granule can be applied dry or can be mixed with water to create a suspension. The at least one microbe or a secondary metabolite thereof can be formulated as a microencapsulation, wherein the at least one microbe or a secondary metabolite thereof has a protective inert layer. The protective inert layer can comprise any suitable polymer.

The biocontrol composition can further comprise an additional compound. The additional compound can be a carrier, a surfactant, a wetting agent, a penetrant, an emulsifier, a spreader, a sticker, a stabilizer, a nutrient, a binder, a desiccant, a thickener, a dispersant, a UV protectant, or a combination thereof. The carrier can be a liquid carrier, a mineral carrier, or an organic carrier. Examples of a liquid carrier include, but are not limited to, vegetable oil or water. Examples of a mineral carrier include, but are not limited to, kaolinite clay or diatomaceous earth. Examples of an organic carrier include, but are not limited to, grain flour. The surfactant can be an anionic surfactant, a cationic surfactant, an amphoteric surfactant, or a nonionic surfactant. The surfactant can be Tween 20 or Tween 80. The wetting agent can comprise a polyoxyethylene ester, an ethoxy sulfate, or a derivative thereof. In some cases, a wetting agent is mixed with a nonionic surfactant. A penetrant can comprise a hydrocarbon. A spreader can comprise a fatty acid, a latex, an aliphatic alcohol, a crop oil (e.g., cottonseed), or an inorganic oil. A sticker can comprise emulsified polyethylene, a polymerized resin, a fatty acid, a petroleum distillate, or pregelantinized corn flour. The oil can be coconut oil, palm oil, castor oil, or lanolin. The stabilizer can be lactose or sodium benzoate. The nutrient can be molasses or peptone. The binder can be gum arabic or carboxymethylcellulose. The desiccant can be silica gel or an anhydrous salt. A thickener can comprise a polyacrylamide, a polyethylene polymer, a polysaccharide, xanthan gum, or a vegetable oil. The dispersant can be microcrystalline cellulose. The UV protectant can be oxybenzone, blankophor BBH, or lignin.

The biocontrol composition can further comprise dipicolinic acid.

The at least one microbe can comprise an effective amount of isolated and purified microbes isolated and purified from a liquid culture. The at least one microbe from the liquid culture can be air-dried, freeze-dried, spray-dried, or fluidized bed-dried to produce a dry formulation. The dry formulation can be reconstituted in a liquid to produce a liquid formulation.

The biocontrol composition can be formulated such that the at least one microbe can replicate once they are applied/or delivered to the target habitat (e.g., the soil, the plant, the seed, and/or the produce).

The biocontrol composition can have a shelf life of at least one week, one month, six months, at least one year, at least two years, at least three years, at least four years, or at least five years. The shelf life can indicate the length of time the biocontrol composition maintains at least 80%, at least 85%, at least 90%, at least 95%, at least 99%, or 100% of its anti-fungal properties. The biocontrol composition can be stored at room temperate, at or below 4° C., at or below 0° C., or at or below −20° C.

The biocontrol composition can comprise spores. Spore-containing compositions can be applied by methods described herein. Spore-containing compositions can extend the shelf life of the biocontrol composition. Spore-containing compositions can survive low pH or low temperatures of a target habitat. For example, spore-containing compositions may be applied to the soil at a colder temperature (for example, below 10° C.) and can have anti-fungal properties for a seed planted at a higher temperature (for example, 20° C.). The spores may become vegetative cells, allowing them any advantages of vegetative cells.

The biocontrol composition can comprise vegetative cells. Vegetative cell-containing compositions can be applied by methods described herein. Vegetative cells may proliferate and increase efficacy of the composition. For example, vegetative cells in the biocontrol composition may proliferate after application increasing the surface area the plant that is exposed to the biocontrol composition. In another example, vegetative cells in the biocontrol composition may proliferate after application increasing the amount of the time the biocontrol composition survives and thus extending the time the biocontrol composition has efficacy. The vegetative cells may proliferate and compete for nutrients with a fungal pathogen. The vegetative cells may actively produce one or more secondary metabolites with anti-fungal properties. The vegetative cells may become spores, allowing them any advantages of spores.

The biocontrol composition can have anti-fungal activity, such as prevention of growth of a fungal pathogen or reduction of growth of a fungal pathogen on a plant, a seed, or a produce thereof. The biocontrol composition can prevent growth of a fungal pathogen on the plant, seed, or produce thereof for at least 1, at least 2, at least 3, at least 4, or at least 5 days. The biocontrol composition can prevent growth of a fungal pathogen on the plant, seed, or produce thereof for at least 1, at least 2, at least 3, at least 4, at least 5 days, at least 6 days, at least 7 days, at least 8 days, at least 9 days, or at least 10 days. The biocontrol composition can prevent growth of a fungal pathogen on the plant, seed, or produce thereof for over 10 days.

The biocontrol composition can reduce growth of the fungal pathogen on the plant, seed, or produce thereof relative to growth of the fungal pathogen on a control that is a plant, a seed, flower, or a produce thereof not exposed to the biocontrol composition. The control can be a plant, a seed, or a produce thereof to which no anti-fungal agent has been applied or can be a plant, a seed, flower, or produce thereof to which a commercially available anti-fungal agent has been applied. Examples of commercially available anti-fungal agents include, but are not limited to, Bacillus subtilis strain QST713 (Serenade®), Bacillus subtilis strain GB02 (Kodiak®), Bacillus subtilis strain MBI 600 (Subtilex®), Bacillus pumilus strain GB34 (YieldShield), Bacillus licheniformis strain SB3086 (EcoGuard®). The biocontrol composition can reduce growth of a fungal pathogen on the plant, seed, or produce thereof for at least 1, at least 2, at least 3, at least 4, or at least 5 days. The biocontrol composition can reduce growth of a fungal pathogen on the plant, seed, or produce thereof for at least 1, at least 2, at least 3, at least 4, at least 5 days, at least 6 days, at least 7 days, at least 8 days, at least 9 days, or at least 10 days. The biocontrol composition can reduce growth of a fungal pathogen on the plant, seed, or produce thereof for over 10 days. The biocontrol composition can reduce growth of the fungal pathogen of at least 25% relative to growth of the fungal pathogen on the control. The biocontrol composition can reduce growth of the fungal pathogen of at least 60% relative to growth of the fungal pathogen on the control. The biocontrol composition can reduce growth of the fungal pathogen of at least 25%, 30%, 35%, 40%, 45%, 50%, 55%, 60% 65%, 70%, 75%, 80%, 85%, 90%, 95%, 99%, or more relative to growth of the fungal pathogen on the control.

In various aspects disclosed herein, a biocontrol composition may be used to reduce growth of a fungal pathogen on a plant. The plant may be a flower, seed or produce. The plant, flower, seed, or produce thereof can be of an almond, apricot, apple, artichoke, banana, barley, beet, blackberry, blueberry, broccoli, Brussels sprout, cabbage, cannabis, capsicum, carrot, celery, chard, cherry, citrus, corn, cucurbit, date, fig, garlic, grape, herb, spice, kale, lettuce, oil palm, olive, onion, pea, pear, peach, peanut, papaya, parsnip, pecan, persimmon, plum, pomegranate, potato, quince, radish, raspberry, rose, rice, sloe, sorghum, soybean, spinach, strawberry, sweet potato, tobacco, tomato, turnip greens, walnut, or wheat. The plant may be a member of the Citrus or Malus genus. For example, the plant may be mandarin, lemon, navel orange, or hybrid thereof. The plant may be an apple. The plant may be a particular cultivar. For example, the apple may be a Fuji apple.

### Methods and Compositions for Prevention or Reduction of Food Rot and Food Spoilage

Treating the Plant, the Seed, Flower, or the Produce Thereof with the Biocontrol Composition Prior to Harvest

The methods may be effective at inhibiting the growth of a fungal pathogen. The methods and may be capable of inhibiting or reducing growth of a fungal pathogen by 25% or more relative to a control not exposed to the biocontrol composition. The methods and may be capable of inhibiting or reducing growth of a fungal pathogen by 60% or more relative to a control not exposed to the biocontrol composition. The methods and compositions may be capable of inhibiting or reducing growth of a fungal pathogen by at least 1%, 2%, 3% 4%, 5%, 6%, 7%, 8%, 9%, 10%, 11%, 12%, 13%, 14%, 15%, 17%, 20%, 25%, 30%, 35%, 40%, 50%, 55%, 60%, 65%, 70%, 75%, 80%, 85%, 90%, 95%, 97%, 98%, 99%, 99.5% or more relative to a control not exposed to the biocontrol composition.

Methods of preventing or reducing the growth of a fungal pathogen on a plant, a seed, or a produce thereof can comprise applying to the plant, the seed, flower, or the produce, before it has been harvested, a biocontrol composition comprising at least one microbe described herein or one or more secondary metabolites thereof and a carrier. Harvesting the produce can refer to the removal of the edible portion of the plant from the remainder of the plant or can refer to removal of the entire plant with subsequent removal of the edible portion later.

Applying the biocontrol composition prior to harvest can comprise dusting, injecting, spraying, or brushing the plant, the seed, or the produce thereof with the biocontrol composition. Applying the biocontrol composition can comprise adding the biocontrol composition to a drip line, an irrigation system, a chemigation system, a spray, or a dip. In some cases, the biocontrol composition is applied to the root of the plant, the seed of the plant, the foliage of the plant, the soil surrounding the plant or the edible portion of the plant which is also referred to herein as the produce of the plant.

The method can further comprise applying to the plant a fertilizer, an herbicide, a pesticide, other biocontrols, or a combination thereof. In some instances, the fertilizer, herbicide, pesticide, other biocontrols or combination thereof is applied before, after, or simultaneous with the biocontrol composition.

Method of preventing or reducing the growth of a fungal pathogen can comprise applying to the seed a biocontrol composition comprising at least one microbe described herein or a secondary metabolite thereof and a carrier. Applying the biocontrol composition to the seed of the plant can occur before planting, during planting, or after planting prior to germination. For example, the biocontrol composition can be applied to the surface of the seed prior to planting. In some cases, a seed treatment occurring before planting can comprise addition of a colorant or dye, a carrier, a binder, a sticker, an anti-foam agent, a lubricant, a nutrient, or a combination thereof to the biocontrol composition.

Method of preventing or reducing the growth of a fungal pathogen can comprise applying to the soil a biocontrol composition comprising at least one microbe described herein or a secondary metabolite thereof and a carrier. The biocontrol composition can be applied to the soil before, after, or during planting the soil with a seed, or before transfer of the plant to a new site. In one example, a soil amendment is added to the soil prior to planting, wherein the soil amendment results in improved growth of a plant, and wherein the soil amendment comprises the biocontrol composition. In some cases, the soil amendment further comprises a fertilizer.

Method of preventing or reducing the growth of a fungal pathogen can comprise applying to the root a biocontrol composition comprising at least one microbe described herein or a secondary metabolite thereof and a carrier. The biocontrol composition can be directly applied to the root. One example of a direct application to the root of the plant can comprise dipping the root in a solution that includes the biocontrol composition. The biocontrol composition can be applied to the root indirectly. One example of an indirect application to the root of the plant can comprise spraying the biocontrol composition near the base of the plant, wherein the biocontrol composition permeates the soil to reach the roots.

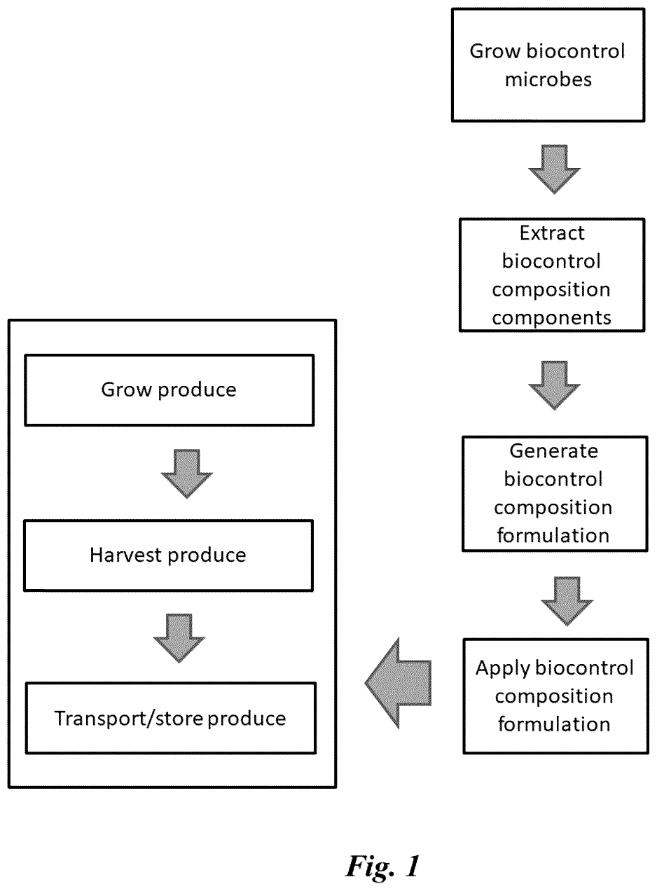

FIG. 1 shows a general schematic of methods of using the biocontrol composition. The microbes may be grown for use in the biocontrol composition. An active component of the biocontrol composition may optionally be extracted, or the microbial growth may be manipulated such that the different components may be used for the biocontrol composition. For example, the microbial growth may be centrifuged, and a supernatant and microbe pellet may be collected. The supernatant or the microbe may be used as the biocontrol composition. Additional compounds may be added to the biocontrol composition and a formulation may be generated. The formulation may for example, increase shelf life or allow the biocontrol composition to be applied. In parallel, a plant may be grown. The plant may be grown from a seed or from a graft. A produce of the plant may be harvested, and the harvested produce may be transported. The formulated biocontrol composition may be applied to the plant at any stage in the plant growth process, or in the harvest or transport process. For example, the biocontrol composition may be applied to the seed or root of the plant. In another example, the biocontrol composition may be applied to the produce prior to harvesting, during harvesting, after harvesting, or applied to a packaging used for transport of the produce. After application of the biocontrol composition, the plant may have increased resilience to pathogenic infection or growth.

Treating the Produce Thereof with the Biocontrol Composition after Harvest

Methods of preventing or reducing the growth of a fungal pathogen on a produce can comprise applying to the produce, before or after it has been harvested, a biocontrol composition comprising at least one microbe described herein or a secondary metabolite thereof and a carrier.

Applying the biocontrol composition before or after harvest can comprise dusting, dipping, rolling, injecting, rubbing, spraying, or brushing the produce of the plant with the biocontrol composition. The biocontrol composition can be applied to the produce immediately prior to harvest or immediately after harvesting or within 1 day, 2 days, 3 days, 4 days, 5 days, 6 days, or 1 week of harvesting. In some cases, the biocontrol composition is applied by the entity doing the harvesting, in a process treating the produce immediately prior to harvest or post-harvest, by the entity packaging the produce, by the entity transporting the produce, or by the entity commercially displaying the produce for sale, or a consumer.

Applying the biocontrol composition after harvest can further comprise integrating the biocontrol composition into a process to treat the produce post-harvest. The produce can be treated immediately post-harvest, for example in one or multiple washes. The one or multiple washes can comprise the use of water that has had bleach (chlorine) and/or sodium bicarbonate added to it, or ozonated water. The produce may also be treated with oils, resins, or structural or chemical matrices. The biocontrol composition may be mixed with the oils, resins, or structural or chemical matrices for application. The produce can be treated before or after drying the produce. For example, the biocontrol composition can be added to a wax, gum arabic or other coating used to coat the produce. The biocontrol composition may be added at any point in the process, included in one of the washes, as part of a new wash, or mixed with the wax, gum arabic or other coating of the produce.

### Potential Formulations of the Biocontrol Composition.

In order to increase the shelf life and ease of application of a biocontrol composition, particular formulations may be used. Formulations may comprise sucrose, glycerol, carboxymethyl cellulose (CMC) gum arabic polyvinylpyrrolidone (PVP), alginate, agar, λ- and κ carrageenan, pectin, chitosan, bean gum, skim milk, starch, or trehalose. The formulation may comprise an amount of a given component up to 100% of the composition. The formulation may contain specific amount of a given component. For example, a given component may comprise at least 0.1%, 1% 5%, 10%, 15%, 20%, 25%, 30%, 35%, 40%, 50%, 55%, 60%, 65%, 70%, 75%, 80%, 85%, 90%, 95%, or more of a composition. For example, a given component may comprise no more than 0.1%, 1% 5%, 10%, 15%, 20%, 25%, 30%, 35%, 40%, 50%, 55%, 60%, 65%, 70%, 75%, 80%, 85%, 90%, 95%, or less of a composition.

For example, the carboxymethyl cellulose (CMC) may be at amount of 1:5 w/v. In another example, the gum arabic may be at a concentration of up to 40% w/v. The formulation may be of various liquid or solid states or may be aerosolizable. For example, the formulation may be a freeze-dried powder. For example, the formulation may be a liquid or originally a liquid prior to being lyophilized.

The following examples are given for the purpose of illustrating various embodiments of the invention and are not meant to limit the present invention in any fashion. The present examples, along with the methods described herein are presently representative of preferred embodiments, are exemplary, and are not intended as limitations on the scope of the invention. Changes therein and other uses which are encompassed within the spirit of the invention as defined by the scope of the claims will occur to those skilled in the art.

### EXAMPLES

### Example 1: Protection by Use of BC8, BC16, BC17, and BC18 Against P. Expansum Infection of Apples

Wounded and inoculated apples were incubated in closed containers and disease incidence and disease severity was evaluated at 4, 6 and 8 days after pest challenge. The diameter of visible infection spreading from the inoculated wound was measured to assess disease severity.

The apples were first disinfected by dipping in fruit in a 10% bleach solution for 8 minutes. The bleached apples were rinsed 3 times with distilled water and allowed to dry for 30 minutes. The apples were artificially wounded using a sterile 4 mm-wide cork-borer and a 3 mm-deep well was cut into the apple. The apples were sorted into sets, with four apples in a set, and photographed. For each treatment, the fruits were inoculated with the treatment by dipping the fruits in a 1/4 dilution of the respective BC composition (BC8, BC16, BC17, or BC18) for 1 minute. The treatment was allowed to dry for at least 3 hours. The container for fruit storage was prepped by wiping the container with a disinfecting wipe and allowed to dry for 20 mins. The bottom of the container was filled with 200 mL of de-ionized water. One side of a petri dish was used to hold the fruit inoculation side up and place fruit in the covered container. Penicillium. expansum was applied at the wound site. Four apples were left uninoculated (25 μL of sterile water). For all treatments, each apple was inoculated with 25 μL of a solution of 1.0e5 spores/mL (2.5e4 absolute spores). The progression of the infection was assessed at 4, 6, and 8 days after storage. To analyze the infection, a lesion diameter read was performed and a photo was taken of the apples. Additionally, the degree of infection was measured by weighing the total apple, cutting out the necrotic area and weighing the apple again to assess the grams of tissue infected.

Experimental conditions are shown in Table 3, with 6 conditions: spores of BC8, BC16, spores of BC17, BC18, untreated control without infecting with a pathogen (UTC no pathogen), and untreated control apples infected by a pathogen (UTC with pathogen), performed on both Gala and Fuji apples with four replicates of each condition.

TABLE 3
Treatment conditions on apples

| Treatment | | | |
|---|---|---|---|
| condition | | Apple | |
| name | Formulation | Type | |
| BC8 spores | BC8: Bacillus amyloliquifaciens | Gala | 4 Replicates |
| | (SEQ ID NO: 1) spores in PBS | | |
| BC16 | BC16: Pseudomonas sp. | Gala | 4 Replicates |
| | (SEQ ID NO: 22) | | |
| | in fermentation | | |
| | broth (nutrient broth | | |
| | plus glycerol) | | |
| BC17 spores | BC17: Bacillus amyloliquifaciens | Gala | 4 Replicates |
| | SEQ ID NO: 23) spores in PBS | | |
| BC18 | BC18: Gluconobacter cerinus | Gala | 4 Replicates |
| | and Hanseniaspora uvarium | | |
| | (SEQ ID NO: 24 and 25) | | |
| | (approx. 50:50 ratio) PBS | | |
| Untreated | | Gala | 4 Replicates |
| Control | | | |
| (UTC)-no | | | |
| pathogen | | | |
| Untreated | | Gala | 4 Replicates |
| Control | | | |
| (UTC) with | | | |
| pathogen | | | |
| BC8 spores | BC8: Bacillus amyloliquifaciens | Fuji | 4 Replicates |
| | (SEQ ID NO: 1)) spores in PBS | | |
| BC16 | BC16: Pseudomonas sp. | Fuji | 4 Replicates |
| | (SEQ ID NO: 22) in fermentation | | |
| | broth (nutrient broth plus glycerol) | | |
| BC17 spores | BC17: Bacillus amyloliquifaciens | Fuji | 4 Replicates |
| | (SEQ ID NO: 23) spores in PBS | | |
| BC18 | BC18: Gluconobacter cerinus | Fuji | 4 Replicates |
| | and Hanseniaspora uvarium | | |
| | (SEQ ID NO: 24 and 25) | | |
| | (approx. 50:50 ratio) PBS | | |
| Untreated | | Fuji | 4 Replicates |
| Control | | | |
| (UTC)-no | | | |
| pathogen | | | |
| Untreated | | Fuji | 4 Replicates |
| Control | | | |
| (UTC) with | | | |
| pathogen | | | |

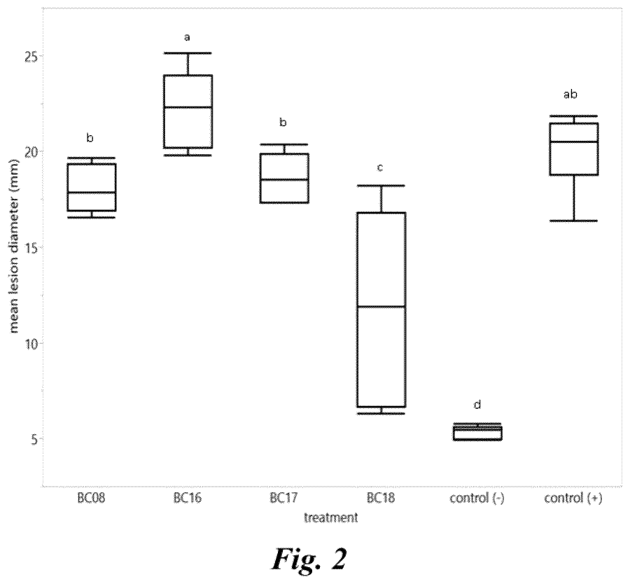

FIG. 2 shows apple decay measured by the lesion diameter across six experiments including Fuji (3) and Gala (3) apples. The negative control (control(−)) is uninoculated and untreated whereas the positive control (control (+)) is inoculated and untreated. Box plots not connected by the same letter are significantly different (p=0.01). Measurements were taken 6 days post-infection.

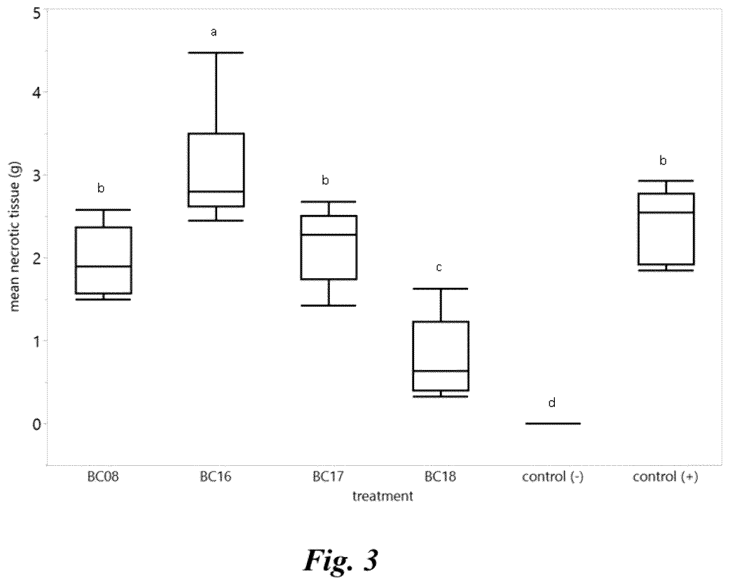

FIG. 3 shows Apple decay measured by the weight of the decayed tissue across six experiments including Fuji (3) and Gala (3) apples. The negative control was uninoculated and untreated whereas the positive control was inoculated and untreated. Box plots not connected by the same letter are significantly different (p=0.01). Measurements were taken 6 days post-infection.

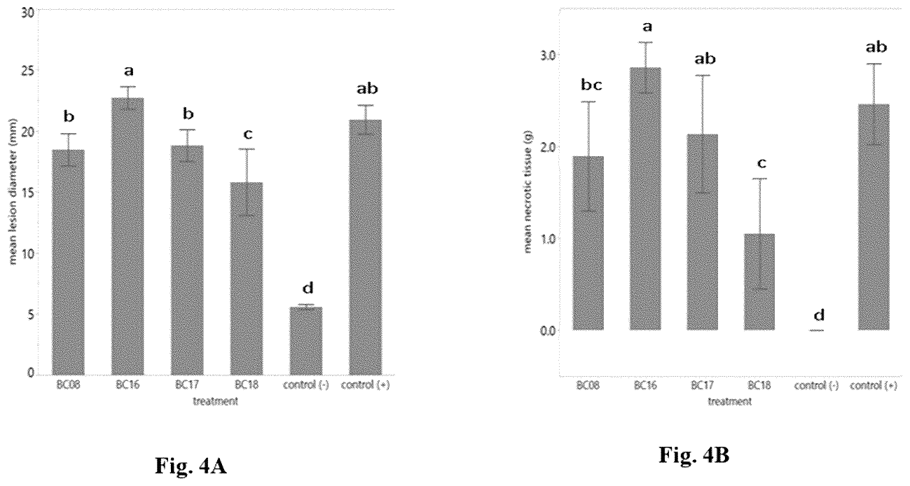

FIG. 4A shows Fuji apple decay assessed by the mean lesion diameter. FIG. 4B shows Fuji apple decay assessed by the mean weight of necrosis. The negative control was uninoculated and untreated whereas the positive control was inoculated and untreated. Bars not connected by the same letter are significantly different (p=0.05). Measurements were taken 6 days post-infection.

BC18 treated apples were shown to be significantly less prone to decay than apples without treatment by either measuring the size or weight of the infection. BC18 mediated protection from decay can be seen in Fuji and Gala apples. BC18 treatment are shown to significantly protect Fuji apples from P. expansum decay when compared to the untreated (+) control. BC18 treatment also significantly protected Gala apples from P. expansum decay. The treatment results in Gala apples are comparable to the uninoculated (−) control apples. Additionally, no adverse effects were noted on the apples treated with the candidates. No unusual odors or discoloration of the apple surface was observed.

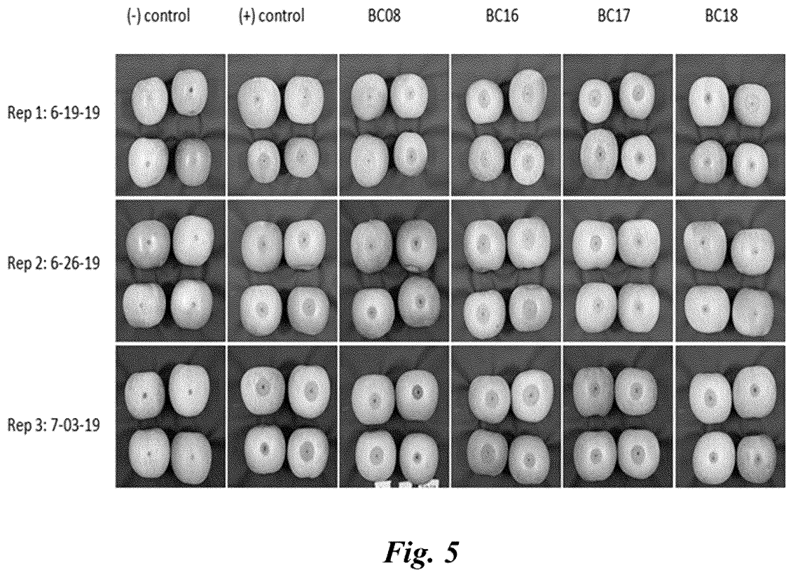

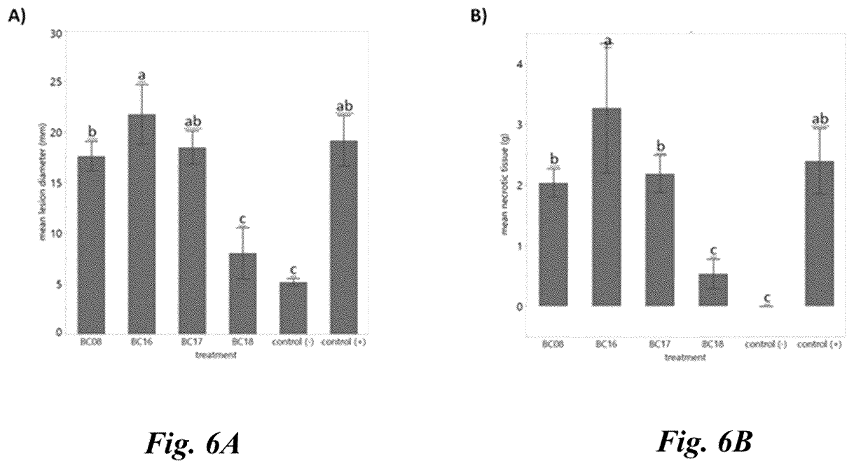

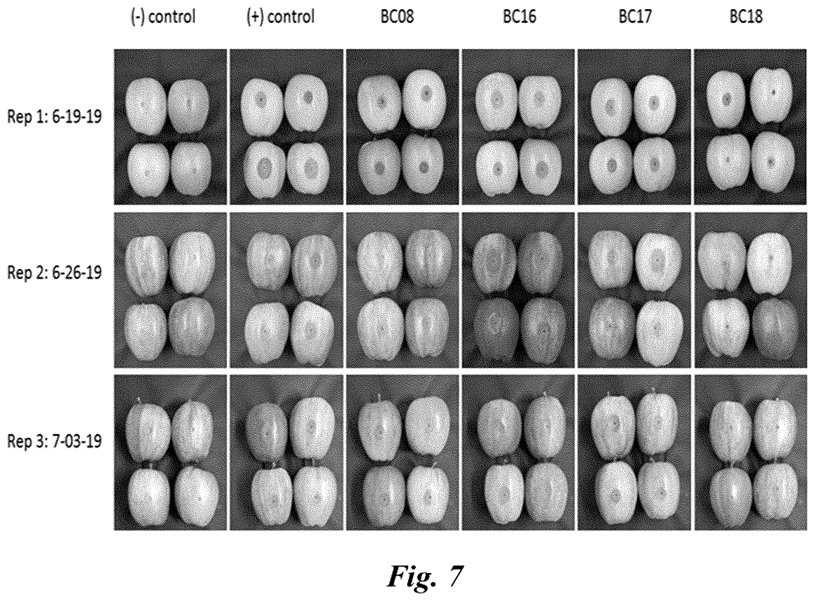

FIG. 5 is a photograph of Fuji Apples 6 days post-infection, and FIG. 7 is a photograph of Gala Apples 6-7 days post-infection. FIG. 6A shows Gala apple decay assessed by the mean lesion diameter. FIG. 6B shows Gala apple decay assessed by the mean weight of necrosis. The negative control is uninoculated and untreated whereas the positive control is inoculated and untreated. Bars not connected by the same letter are significantly different (p=0.05). Measurements were taken 6 days post-infection.

### Example 2: Protection from P. expansum Decay on Apples by BC18 Component Strains

Wounded and inoculated apples are incubated in closed containers. Disease incidence and disease severity are evaluated at 6 days after pest challenge. The diameter of visible infection spreading from the inoculated wound are measured to assess disease severity. The two strains that make up BC18 (Gluconobacter cerinus=BC18A and Hanseniaspora uvarium=BC18B) are tested in the same way as single strains. Additionally, various ratio of the BC18 components are tested. Experimental conditions are shown in Table 4, with 8 conditions (BC18, BC18 microbe A (BC18A), BC18 microbe B (BC18B), BC18 microbe A and microbe B at a first ratio of amounts of microbe A and B (BC18A+B ratio 1), BC18 microbe A and microbe B at a second ratio of amounts of microbe A and B (BC18A+B ratio 2)), BC18 microbe A and microbe B at a third ratio of amounts of microbe A and B (BC18A+B ratio 3), untreated control without infecting with a pathogen (UTC no pathogen), and untreated control apples infected by a pathogen (UTC with pathogen), performed of Gala apples with four replicates of each condition.

TABLE 4
BC18 Treatment Conditions on apples

| Treatment | | Apple | |
|---|---|---|---|
| condition | Formulation | Type | |
| BC18 | Gluconobacter cerinus | Gala | 4 Replicates |
| | and Hanseniaspora | | |
| | uvarium in Phosphate | | |
| | Buffered Saline (PBS) | | |
| BC18A | Gluconobacter cerinus in | Gala | 4 Replicates |
| | Phosphate Buffered | | |
| | Saline (PBS) | | |
| BC18B | Hanseniaspora uvarium | Gala | 4 Replicates |
| | in Phosphate | | |
| | Buffered Saline (PBS) | | |
| BC18A + B; | Gluconobacter cerinus | Gala | 4 Replicates |
| 1:2 ratio | and Hanseniaspora | | |
| | uvarium in a 1:2 ratio in | | |
| | Phosphate Buffered | | |
| | Saline (PBS) | | |
| BC18A + B; | Gluconobacter cerinus | Gala | 4 Replicates |
| 2:1 ratio | and Hanseniaspora | | |
| | uvarium in a 2:1 ratio | | |
| | in Phosphate Buffered | | |
| | Saline (PBS) | | |
| BC18A + | Gluconobacter cerinus | Gala | 4 Replicates |
| B; 1:1 | and Hanseniaspora | | |
| | uvarium in a 1:1 ratio | | |
| | in Phosphate Buffered | | |
| | Saline (PBS) | | |
| Untreated | | Gala | 4 Replicates |
| Control | | | |
| (no | | | |
| pathogen) | | | |
| Untreated | | Gala | 4 Replicates |
| Control | | | |
| with | | | |
| pathogen | | | |

The apples are first disinfected by dipping in fruit in a 10% bleach solution for 8 minutes. The bleached apples are rinsed 3 times with distilled water and allowed to dry for 30 minutes. The apples are artificially wounded using a sterile 4 mm-wide cork-borer and a 3 mm-deep well is cut into the apple. The apples are sorted into sets, with four apples in a set and photographed. For each treatment, the fruit are inoculated with the treatment by dipping the fruits in a 1/4 dilution of the respective BC composition for 1 minute. The treatment is allowed to dry for at least 3 hours. The container for fruit storage is prepped by wiping the container with a disinfecting wipe and allowed to dry for 20 mins. The bottom of the container is filled with 200 mL of de-ionized water. One side of a petri dish is used to hold the fruit inoculation side up and place fruit in the covered container. Penicillium. expansum is applied at the wound site. Four apples are left uninoculated (25 μL of sterile water). For all treatments, each apple is inoculated with 25 μL of a solution of 1.0e5 spores/mL (2.5e4 absolute spores). The progression of the infection is assessed at 4, 6, and 8 days after storage. To analyze the infection, a lesion diameter read is performed and a photo is taken of the apples. Additionally, the degree of infection is measured by weighing the total apple, cutting out the necrotic area and weighing the apple again to assess the grams of tissue infected.

An optimal ratio of BC18A and BC18B is ascertained as well as relative contributions of BC18A and BC18B. Synergistic effects of co-culturing can be observed which can be compared against the strains that are grown separately. Synergistic effects may be observed due to mutual stimulation of antifungal metabolites.

### Example 3: Protection from Botrytis cinerea Decay on Strawberries by BC8, BC16, BC17, and BC18

Wounded and inoculated strawberries are incubated in closed containers and disease incidence and disease severity are evaluated at 4, 6 8 days after pest challenge. The diameter of visible infection spreading from the inoculated wound are measured to assess disease severity. Experimental conditions are shown in Table 5, with 6 conditions, spores of BC8, BC16, spores of BC17, BC18 microbe, untreated control without infecting with a pathogen (UTC no pathogen), and untreated control apples infected by a pathogen (UTC with pathogen), performed on strawberries with four replicates of each condition

TABLE 5
Treatment Conditions on strawberries

| Treatment | | |
|---|---|---|
| condition | Formulation | |
| BC8 spores | BC8: Bacillus amyloliquifaciens | 4 Replicates |
| | (SEQ ID NO: 1) | |
| | spores in PBS | |
| BC16 | BC16: Pseudomonas sp. | 4 Replicates |
| | (SEQ ID NO: 22) in | |
| | fermentation broth (nutrient | |
| | broth plus glycerol) | |
| BC17 spores | BC17: Bacillus amyloliquifaciens | 4 Replicates |
| | (SEQ ID NO: 23) | |
| | spores in PBS | |
| BC18 | BC18: Gluconobacter cerinus | 4 Replicates |
| | and Hanseniaspora | |
| | uvarium (SEQ ID NO: 24 and 25) | |
| | (approx. 50:50 ratio) PBS | |
| UTC no | | 4 Replicates |
| pathogen | | |
| UTC with | | 4 Replicates |
| pathogen | | |

The strawberries are first disinfected fruit surface by dipping in fruit in a 10% bleach solution for 8 minutes. The bleached strawberries are rinsed 3 times with distilled water and allowed to dry for 30 minutes. The strawberries are artificially wounded using a sterile 4 mm-wide cork-borer and a 3 mm-deep well is cut into the strawberry. The strawberries are sorted into sets, with four strawberries in a set and photographed. For each treatment, the fruit are inoculated with the treatment by dipping the fruits in a 1/4 dilution of the respective BC composition for 1 minute. The treatment is allowed to dry for at least 3 hours. The container for fruit storage was prepped by wiping the container with a disinfecting wipe and allowed to dry for 20 mins. The bottom of the container was filled with 200 mL of de-ionized water. One side of a petri dish is used to hold the fruit inoculation side up and place fruit in the covered container. Botrytis cinerea is applied at the wound site. Four strawberries are left uninoculated (25 μL of sterile water). For all treatments, each strawberry is inoculated with 25 μL of a solution of 1.0e5 spores/mL (2.5e4 absolute spores). The progression of the infection is assessed at 4, 6, and 8 days after storage. To analyze the infection, a lesion diameter read is performed and a photo is taken of the apples. Additionally, the degree of infection is measured by weighing the total apple, cutting out the necrotic area and weighing the apple again to assess the grams of tissue infected.

### Example 4. Inhibition of Penicillium Digitatum by BC8, BC17 and BC18 in Vitro on Various Citrus-Based Media

Citrus-based media were made from homogenized fruit tissue, water, and agar. Homogenized fruit tissue was made by blending each fruit tissue type to generate a corresponding media for mandarin, lemon, or navel. 6 types of media were made: mandarin rind, complete mandarin, lemon rind, complete lemon, navel rind, or complete navel using a blender. A complete media includes both rind and flesh of the fruit, whereas the rind media was produced with the rind and without the flesh of the fruit. After autoclaving the citrus-based media, the citrus media was poured into petri dishes to make solid media plates.

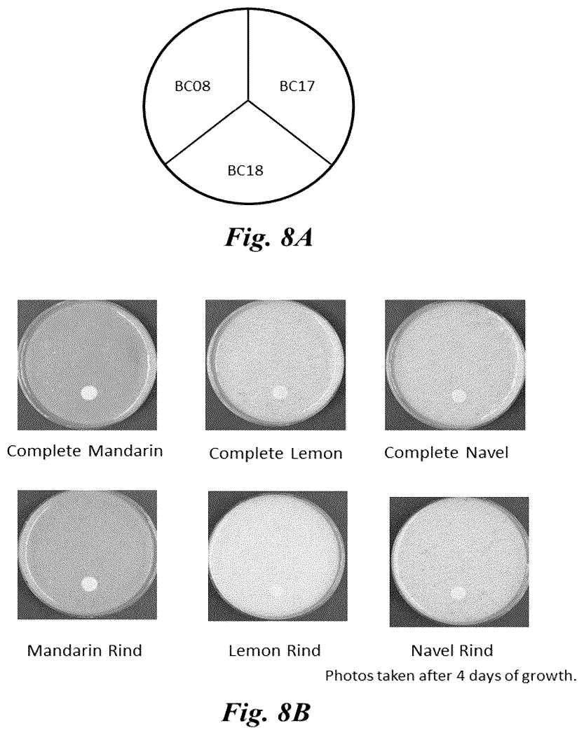

In order to determine growth capabilities of BC8, BC17, and BC18 microorganism consortia on citrus agar media, 4 μL of each microorganism consortium was spotted onto solid citrus media plates as shown in FIG. 8A. Cultures were grown at room temperature for 4 days. Photographic pictures of the citrus media plates are shown in FIG. 8B illustrating the growth of BC8, BC17, and BC18 after 4 days. BC8 and BC17 did not show noticeable visible colony growth on any of the plates, while BC18 showed colony growth on all citrus media types.

The microorganism BC8 comprising Bacillus amyloliquefaciens, the BC17 microorganism comprising Bacillus sp. and the microorganism consortium BC18 comprising Gluconobacter cerinus and Hanseniaspora uvarum were tested for ability to inhibit Penicillium digitatum (P. digitatum) growth on various citrus-based media, prepared as described hereinbefore.

P. digitatum lawns were spread onto plates at 500 spores/plate or 5000 spores/plate concentrations using 50 uL of spore suspension. Center plugs were cut into each plate after the lawns dried. Candidate suspensions were prepared by picking a single colony from the working stock plates and inoculating it into 1.5 mL of filter-sterilized deionized water. 100 uL of a microorganism consortium was inoculated into center plugs. Plates were left to incubate at room temperature for 4-5 days. Extent of inhibition of P. digitatum was assessed by measuring a zone of clearance on the fungal lawn. Control plates with no microorganism consortium inoculate was used to show 0% inhibition.

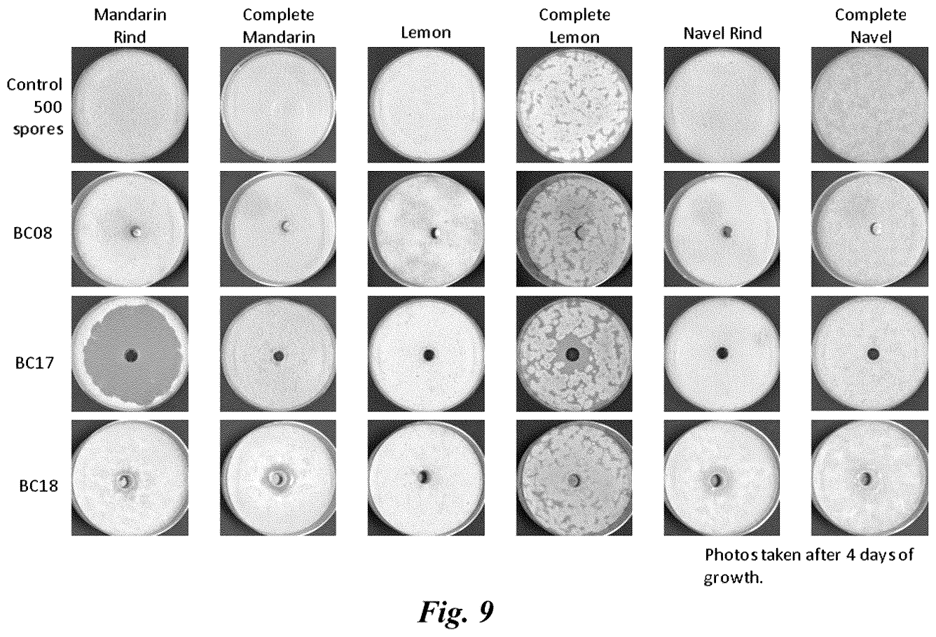

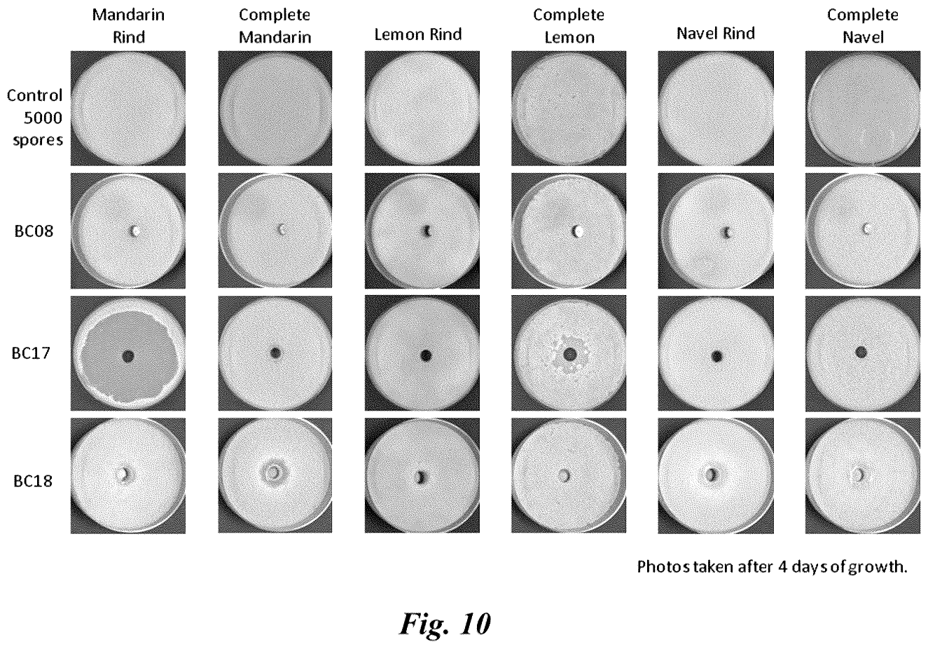

The results at day 4 post inoculation are shown in plates with P. digitatum at 500 spores/plate inoculation concentration (FIG. 9) and at 5000 spores/plate inoculation concentration (FIG. 10). The results were comparable in both concentrations, although P. digitatum growth inhibition was more visible in plates with the inoculation concentration of 500 spores/plate (FIG. 9). BC8 showed no inhibition of P. digitatum on any of the citrus agar plates tested. BC17 showed inhibition of P. digitatum on multiple media.

For BC17, there was strong inhibition on mandarin rind medium and minimal inhibition on complete mandarin medium. There was no visible inhibition on lemon rind medium, and clear inhibition on complete lemon medium. There was no visible inhibition of P. digitatum on navel rind and on complete navel media (FIGS. 9 and 10).

BC18 showed little inhibition of P. digitatum on mandarin rind medium, and clear inhibition on complete mandarin medium. On lemon rind medium there was minimal inhibition, and there was no inhibition on complete lemon medium. For both navel rind and complete navel media, BC18 showed clear inhibition against P. digitatum (FIGS. 9 and 10). Despite the lack of visible growth of BC8 and BC17 on the citrus fruit media, inhibition of the pathogen was still observed demonstrating a potential metabolite of the biocontrol compositions having inhibitory properties.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments described herein may be employed. It is intended that the following claims define the scope of the invention and that methods and structures within the scope of these claims and their equivalents be covered thereby.

1. A biocontrol composition, comprising:
(i) at least one microbe, or a metabolite produced by said at least one microbe, and
(ii) a carrier,
wherein said at least one microbe comprises
(a) a 16S rRNA sequence that is greater than 99% identical to a 16S rRNA sequence of SEQ ID NO: 1, SEQ ID NO: 22, or SEQ ID NO: 23, or
(b) (1) a 16S rRNA sequence that is greater than 90% identical to a 16S rRNA sequence of SEQ ID NO: 24, and/or (2) an internal transcribed spacer (ITS) sequence that is greater than 90% identical to an ITS sequence of SEQ ID NO: 25, and
wherein said biocontrol composition is capable of inhibiting growth of a Penicillium species relative to a control that is not exposed to said biocontrol composition.

2. (canceled)

3. (canceled)

4. The biocontrol composition of claim 1, wherein said 16S rRNA sequence is greater than 99% identical to a 16S rRNA sequence of SEQ ID NO: 23.

5.-9. (canceled)

10. The biocontrol composition of claim 1, wherein said at least one microbe is at least two microbes comprising a first microbe comprising said 16S rRNA sequence that is greater than 90% identical to said 16S rRNA sequence of SEQ ID NO: 24 and a second microbe comprising said ITS sequence that is greater than 90% identical to said ITS sequence of SEQ ID NO: 25.

11. The biocontrol composition of claim 1, wherein growth inhibition of said Penicillium species is shown by a reduction in lesion size or tissue necrosis in produce to which said biocontrol composition as compared to said control that is not exposed to said biocontrol composition.

12. The biocontrol composition of claim 1, wherein said biocontrol composition is capable of inhibiting growth of said Penicillium species 5% or more relative to a control not exposed to said biocontrol composition.

13.-15. (canceled)

16. The biocontrol composition of claim 1, wherein said Penicillium is a Penicillium expansum or Penicillium digitatum.

17. (canceled)

18. The biocontrol composition of claim 1, wherein said biocontrol composition comprises a vegetative cell or spore.

19. (canceled)

20. The biocontrol composition of claim 1, wherein said carrier is selected from the group consisting of: oil, water, wax, resin, kaolinite clay, diatomaceous earth, or grain flour.

21. (canceled)

22. The bio control composition of claim 1, wherein said biocontrol composition is formulated in a liquid form, solid form, or powder form.

23. (canceled)

24. (canceled)

25. A method of reducing or preventing the growth of a pathogen on a plant, a seed, a flower, or a produce thereof comprising: applying the biocontrol composition of claim 1 to said plant, seed flower or produce thereof, or to an object or area adjacent to said plant, seed flower or produce thereof.

26. (canceled)

27. The method of claim 25, wherein said applying is performed prior to harvesting said plant, seed, flower, or produce.

28. The method of claim 25, wherein said applying is performed after harvesting said plant, seed, flower, or produce.

29. The method of claim 25, where said area adjacent to said plant comprises soil used to grow said plant, seed, flower, or produce thereof.

30. The method of claim 25, where said object adjacent to said plant comprises packaging used to store or transport said plant, seed, flower, or produce.

31. The method of claim 25, wherein said applying is performed by spraying said biocontrol composition or dipping a plant, a seed, a flower, or a produce in said biocontrol composition.

32. (canceled)

33. The method of claim 25, wherein said plant is selected from the group consisting of almond, apricot, apple, artichoke, banana, barley, beet, blackberry, blueberry, broccoli, Brussels sprout, cabbage, cannabis, canola, capsicum, carrot, celery, chard, cherry, citrus, corn, cucurbit, date, fig, flax, garlic, grape, herb, spice, kale, lettuce, mint, oil palm, olive, onion, pea, pear, peach, peanut, papaya, parsnip, pecan, persimmon, plum, pomegranate, potato, quince, radish, raspberry, rose, rice, sloe, sorghum, soybean, spinach, strawberry, sweet potato, tobacco, tomato, turnip greens, walnut, and wheat.

34.-37. (canceled)

38. A method of inhibiting growth of a pathogen, comprising:
applying a biocontrol composition to an apple, wherein said biocontrol composition comprises:
(i) at least one microbe, or a metabolite produced by said at least one microbe, and
(ii) a carrier,
wherein (a) said at least one microbe comprises a 16S rRNA sequence that is greater than 99% identical to a 16S rRNA sequence of SEQ ID NO: 1, SEQ ID NO: 22, or SEQ ID NO: 23, or (b) or wherein said at least one microbe comprises a first microbe and a second microbe, and said first microbe comprising said 16S rRNA sequence is greater than 90% identical to said 16S rRNA sequence of SEQ ID NO: 24 and said second microbe comprising said ITS sequence is greater than 90% identical to said ITS sequence of SEQ ID NO: 25,
and
wherein said biocontrol composition is capable of inhibiting growth of Penicillium expansum relative to a control that is not exposed to said biocontrol composition.

39. (canceled)

40. (canceled)

41. The method of claim 38, wherein said 16S rRNA sequence is greater than 99% identical to a 16S rRNA sequence of SEQ ID NO: 23.

42.-46. (canceled)

47. A method of inhibiting growth of a pathogen, comprising:
applying a biocontrol composition to a citrus plant, wherein said biocontrol composition comprises:
(i) at least one microbe, or a metabolite produced by said at least one microbe, and
(ii) a carrier,
wherein (a) said at least one microbe comprises a 16S rRNA sequence that is greater than 99% identical to a 16S rRNA sequence of SEQ ID NO: 1, SEQ ID NO: 22, or SEQ ID NO: 23, or (b) said at least one microbe comprises a first microbe and a second microbe, and said first microbe comprising said 16S rRNA sequence is greater than 90% identical to said 16S rRNA sequence of SEQ ID NO: 24 and said second microbe comprising said ITS sequence is greater than 90% identical to said ITS sequence of SEQ ID NO: 25,
and
wherein said biocontrol composition is capable of inhibiting growth of a Penicillium expansum species relative to a control that is not exposed to said biocontrol composition.

48. (canceled)

49. (canceled)

50. The method of claim 47, wherein said 16S rRNA sequence is greater than 99% identical to a 16S rRNA sequence of SEQ ID NO: 23.

51.-55. (canceled)
